(19) United States
(12) Patent Application Publication
(10) Pub. No.: US 2026/0295783 A1
(43) Pub. Date: Oct. 1, 2026

(54) IMPACT TOOL

(71) Applicant: MAKITA CORPORATION, Anjo-shi (JP)

(72) Inventors: Yuta SUZUKI, Anjo-shi (JP); Tomoro AOYAMA, Anjo-shi (JP); Yuya OKADA, Anjo-shi (JP)

(73) Assignee: MAKITA CORPORATION, Anjo-shi (JP)

(21) Appl. No.: 19/575,997

(22) Filed: Mar. 24, 2026

(30) Foreign Application Priority Data
Mar. 26, 2025 (JP) 2025-051724

(51) Int. Cl. B25B 21/02

(52) U.S. Cl. CPC B25B 21/02

(57) ABSTRACT

An impact tool includes: a motor including a rotor rotatable about a rotation axis extending in a front-rear direction and a stator to rotate the rotor; a motor housing portion that houses the motor; a grip portion extending downward from the motor housing portion; a battery holding portion that is disposed below the grip portion and detachably holds a battery pack for supplying electric power to the motor; a spindle that is rotated by the rotor and extends along the rotation axis; a hammer rotated by the spindle; an anvil that is disposed forward of the hammer and includes, at a distal end thereof, a tip tool holder having a width across flats of 1 inch or more in a cross section orthogonal to the rotation axis; and a spring that biases the hammer toward the anvil. The maximum tightening torque of the anvil is 2500 Nm or more.

### CROSS-REFERENCE TO RELATED APPLICATION(S)

The present application claims priority to and incorporates by reference the entire contents of Japanese Patent Application No. 2025-051724 filed in Japan on Mar. 26, 2025.

### TECHNICAL FIELD

The techniques disclosed in the present specification relate to an impact tool.

### BACKGROUND

There is a known pistol-shaped (or T-shaped) impact tool disclosed in JP 2021-112816 A. In the pistol-shaped impact tool, a grip extends downward with respect to a portion housing a motor and an impact mechanism, and has a T-shape when viewed from the side. The pistol-shaped impact tool is employed in small to medium size models. In larger models, a shape called an in-line type is adopted in which a grip is disposed rearward of the motor and the impact mechanism and the impact tool is held with both hands together with another grip on the front side. The pistol-shaped impact tool has a small dimension in a front-rear direction and is easy to handle.

Impact tools include a battery-powered model in which a battery pack is mounted, and a wired model in which a power cable or an air tube (air type) is connected. Since the battery-powered model is cable-free, the battery-powered model can be used without restriction on location and is easy to handle.

A tip tool size that can be attached to an impact tool is determined by the size of a tip tool holder provided on an anvil. An impact tool to which a large tip tool can be attached requires a higher tightening torque in order to tighten a large fastening member (such as a bolt). Pistol-shaped battery-powered impact tools are also required to be able to mount a large tip tool thereon and generate high tightening torque.

One non-limiting object of the present teachings is to improve the tightening torque in the pistol-shaped battery-powered impact tool.

### SUMMARY OF THE INVENTION

In one non-limiting aspect of the present teachings, an impact tool may include: a motor including a rotor that is rotatable about a rotation axis extending in a front-rear direction and a stator to rotate the rotor; a motor housing portion that houses the motor; a grip portion that extends downward from the motor housing portion; a battery holding portion that is disposed below the grip portion and detachably holds a battery pack for supplying electric power to the motor; a spindle that is rotated by the rotor and extends along the rotation axis; a hammer that is rotated by the spindle; an anvil that is disposed forward of the hammer and includes, at a distal end thereof, a tip tool holder having a width across flats of 1 inch or more in a cross section orthogonal to the rotation axis; and a spring that biases the hammer toward the anvil. A maximum tightening torque of the anvil may be 2500 Nm or more.

According to the present teachings, the tightening torque can be improved in the pistol-shaped battery-powered impact tool.

### BRIEF DESCRIPTION OF THE DRAWINGS

FIG. 1 is a front perspective view illustrating an impact tool according to an embodiment;

FIG. 2 is a rear perspective view illustrating the impact tool according to the embodiment;

FIG. 3 is a right side view illustrating the impact tool according to the embodiment;

FIG. 4 is a longitudinal sectional view illustrating the impact tool according to the embodiment;

FIG. 5 is a longitudinal sectional view illustrating an upper portion of the impact tool according to the embodiment;

FIG. 6 is a perspective view illustrating a gear case and a speed reduction mechanism viewed from a front side;

FIG. 7 is a cross-sectional view illustrating an inside of a motor housing portion of the impact tool according to the embodiment;

FIG. 8 is a perspective view illustrating a side handle according to the embodiment;

FIG. 9 is a cross-sectional view illustrating an impact mechanism according to the embodiment;

FIG. 10 is a side view illustrating a spindle according to the embodiment;

FIG. 11 is a perspective view illustrating a hammer according to the embodiment;

FIG. 12 is a perspective view illustrating an anvil according to the embodiment; and

FIG. 13 is a cross-sectional view illustrating a tip tool holder according to the embodiment.

### DETAILED DESCRIPTION OF PREFERRED EMBODIMENTS

In one or more embodiments, an impact tool may include: a motor having a rotor that is rotatable about a rotation axis extending in a front-rear direction and a stator to rotate the rotor; a motor housing portion that houses the motor; a grip portion that extends downward from the motor housing portion; a battery holding portion that is disposed below the grip portion and detachably holds a battery pack for supplying electric power to the motor; a spindle that is rotated by the rotor and extends along the rotation axis; a hammer that is rotated by the spindle; an anvil that is disposed forward of the hammer and includes, at a distal end thereof, a tip tool holder having a width across flats of 1 inch or more in a cross section orthogonal to the rotation axis; and a spring that biases the hammer toward the anvil. The maximum tightening torque of the anvil may be 2500 Nm or more.

In the above configuration, a pistol-shaped battery-powered impact tool, which includes: the motor; the motor housing portion that houses the motor; the grip portion that extends downward from the motor housing portion; and the battery holding portion that is disposed below the grip portion, can be mounted with a large tip tool of 1 inch or more, and can provide the tightening torque of 2500 Nm or more to the fastening member. Accordingly, the tightening torque can be improved in the pistol-shaped battery-powered impact tool.

In the one or more embodiments, a weight of the hammer may be 800 g or more.

In the above configuration, an impact force of the hammer is improved, so that a higher tightening torque can be achieved in the pistol-shaped battery-powered impact tool.

In the one or more embodiments, the number of impacts per rotation of the hammer may be larger than 1.

In the above configuration, the number of impacts of the hammer is increased, so that a higher tightening torque can be achieved in a short time in the pistol-shaped battery-powered impact tool.

In the one or more embodiments, a moment of inertia of the hammer may be 900 kg·m² or more.

In the above configuration, the impact force of the hammer is improved, so that a higher tightening torque can be achieved in the pistol-shaped battery-powered impact tool.

In the one or more embodiments, a diameter of the hammer may be 70 mm or more. A total length of the hammer may be 35 mm or more.

In the above configuration, the diameter of the hammer is increased, so that the impact force of the hammer can be effectively improved.

In the one or more embodiments, the total length of the hammer may be 60% or less of the diameter of the hammer.

In the above configuration, it is possible to suppress the dimension in the front-rear direction while improving the impact force of the hammer. Since an increase in the front-rear dimension of the pistol-shaped impact tool is suppressed, it is possible to retain easy handling as a strong feature of the pistol-shaped impact tool even when the tightening torque is improved.

In the one or more embodiments, the hammer may rotate about a rotation axis while moving in the front-rear direction along the spindle so as to impact the anvil in a rotation direction. The moving distance of the hammer in the front-rear direction along the spindle may be 12 mm or more and 25 mm or less.

In the above configuration, even when a higher tightening torque is achieved, it is possible to suppress an increase in the moving distance of the hammer in the front-rear direction. As a result, easy handling that is the feature of the pistol-shaped impact tool can be maintained.

In the one or more embodiments, a nut-busting torque of the anvil may be 2800 Nm or more. The nut-busting torque is a torque applied to a fastening member when loosening the fastening member in a tightened state.

In the above configuration, it is possible to achieve a higher nut-busting torque required when loosening the fastening member firmly stuck due to rust or the like.

In the one or more embodiments, a weight of the anvil may be 500 g or more.

The above configuration contributes to achieving a higher tightening torque.

In the one or more embodiments, a moment of inertia of the anvil may be 85.0 kg·mm² or more.

The above configuration contributes to achieving a higher tightening torque.

In the one or more embodiments, a spring constant of the spring may be 80 N/mm or more.

In the above configuration, an elastic force required when the hammer is increased in size can be generated even with a short stroke. Since the moving distance of the hammer in the front-rear direction can be suppressed, it is possible to suppress an increase in the dimension of the impact tool in the front-rear direction.

In the one or more embodiments, the impact tool may include a hammer case that is disposed forward of the motor housing portion and houses a part of the hammer and the anvil while protruding the tip tool holder forward. A distance between a central axis of the anvil and an upper surface of the hammer case in an up-down direction may be 58 mm or less.

In the above configuration, the distance in the up-down direction from the upper surface of the impact tool to the central axis of the anvil is shortened. As a result, convenience of working in places where space is limited is improved, such as when tightening the fastening member at a corner of a structure.

In the one or more embodiments, a nominal diameter of the motor may be 50 mm or more. A stacking thickness of the stator may be 20 mm or more.

In the above configuration, a motor output (hammer rotation speed and rotation torque) required for improving the tightening torque can be achieved.

In the one or more embodiments, the impact tool may further include a trigger lever that is operated to start the motor. The trigger lever may be disposed downward of the motor housing portion on the grip portion.

In the above configuration, the pistol-shaped battery-powered impact tool can perform the tightening work by operating the trigger lever of the grip portion.

Hereinafter, embodiments will be described with reference to the drawings. In the embodiments, a positional relationship of each component will be described using terms of “left”, “right”, “front”, “rear”, “up”, and “down”. These terms indicate relative positions or directions with respect to the center of the impact tool.

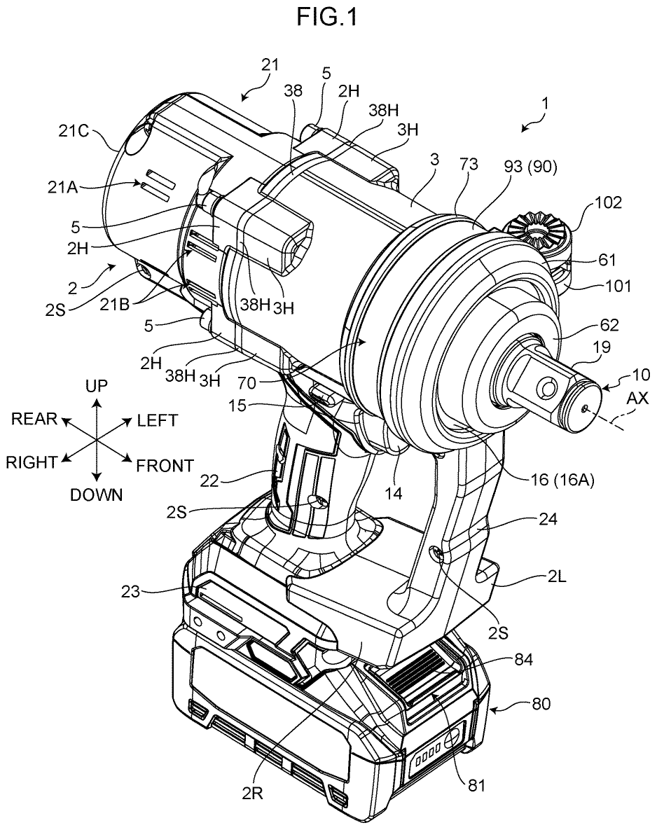

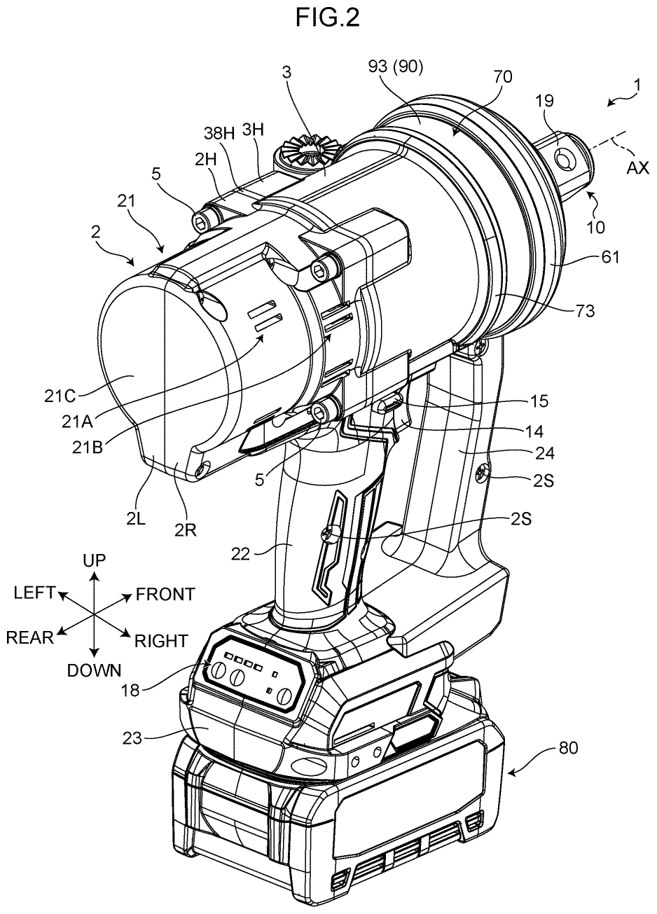

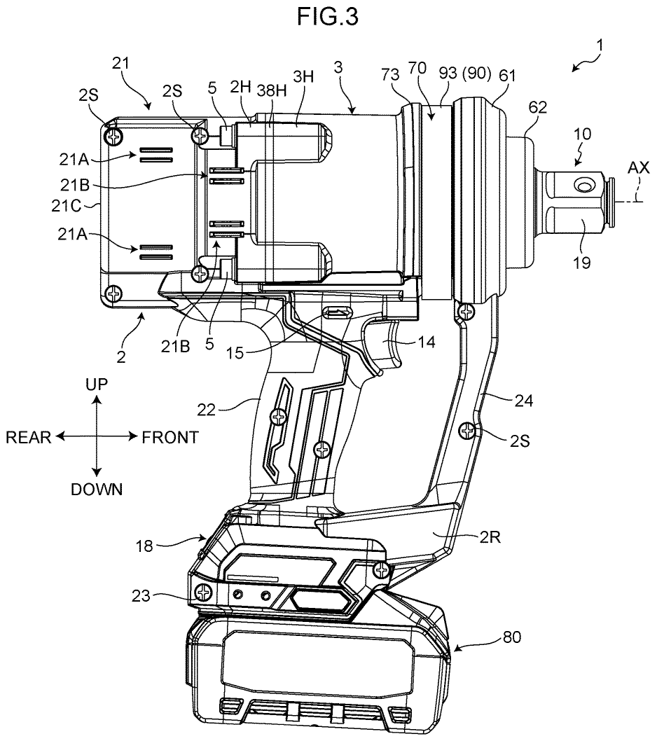

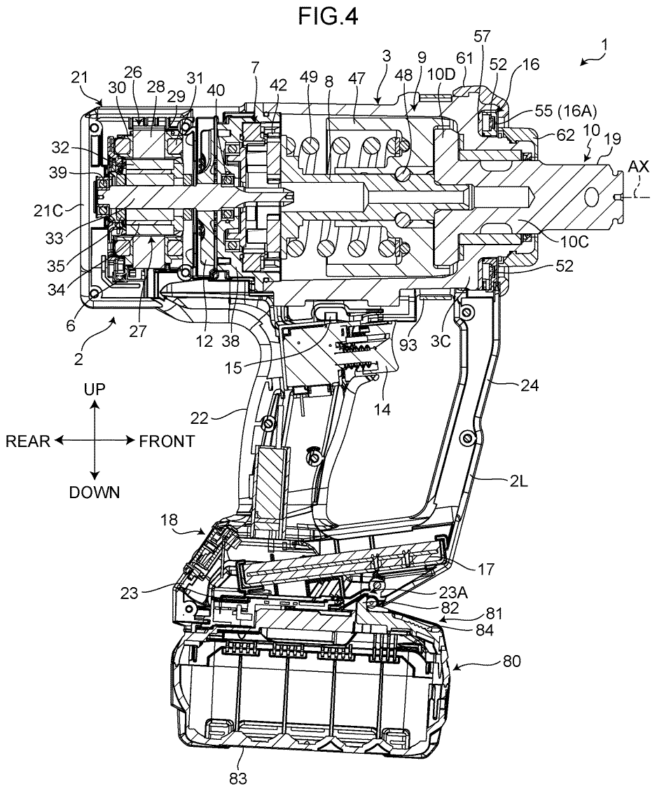

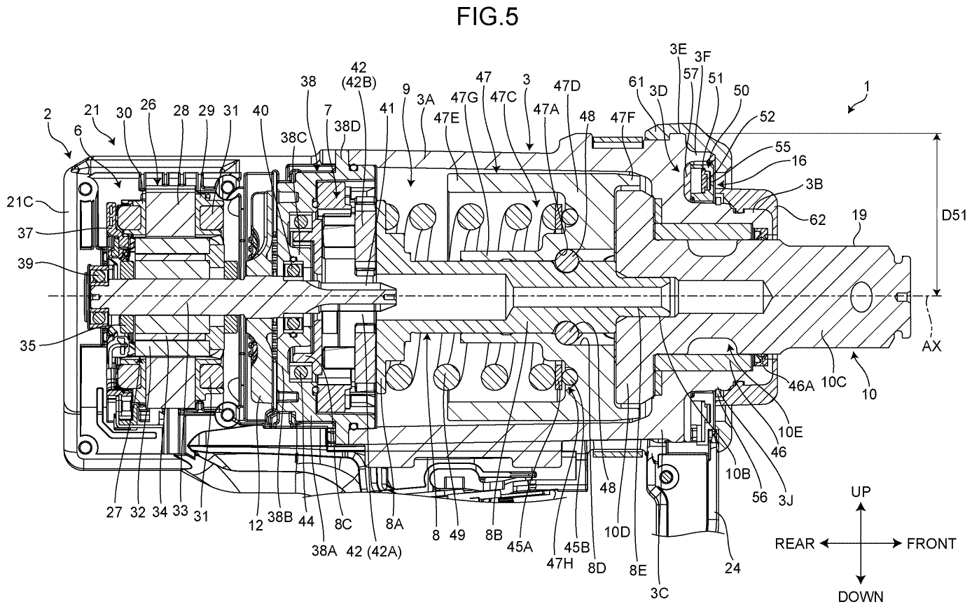

FIG. 1 is a front perspective view illustrating an impact tool 1 according to an embodiment. FIG. 2 is a rear perspective view illustrating the impact tool 1 according to the embodiment. FIG. 3 is a right side view illustrating the impact tool 1 according to the embodiment. FIG. 4 is a longitudinal sectional view illustrating the impact tool 1 according to the embodiment. FIG. 5 is a longitudinal sectional view illustrating an upper portion of the impact tool 1 according to the embodiment.

In the embodiment, the impact tool 1 is an electric tool having an electric motor 6 as a power source. A direction parallel to a rotation axis AX of the motor 6 is referred to as an axial direction as appropriate, a direction around the rotation axis AX is referred to as a circumferential direction or a rotation direction as appropriate, and a radiation direction of the rotation axis AX is referred to as a radial direction as appropriate. In the radial direction, a position close to or a direction approaching the rotation axis AX is referred to as “radially inward” or a radial inner side as appropriate, and a position far from or a direction away from the rotation axis AX is referred to as “radially outward” or a radial outer side as appropriate. In the embodiment, the rotation axis AX extends in a front-rear direction. One side in the axial direction is a front side (forward), and the other side in the axial direction is a rear side (rearward).

In the embodiment, the impact tool 1 is an impact wrench. The impact tool 1 includes a housing 2, a hammer case 3, screws 5, the motor 6, a speed reduction mechanism 7, a spindle 8, an impact mechanism 9, an anvil 10, a fan 12, a trigger lever 14, a forward/reverse switching lever 15, and a light emitter unit 16.

The housing 2 is made of synthetic resin. In the embodiment, the housing 2 is made of nylon. The housing 2 includes a left housing 2L and a right housing 2R disposed on the right side of the left housing 2L. The left housing 2L and the right housing 2R are fixed by a plurality of screws 2S. The housing 2 is configured with a pair of half-split housings.

The housing 2 includes a motor housing portion 21, a grip portion 22, a battery holding portion 23, and a prop 24.

The motor housing portion 21 is cylindrical. The motor housing portion 21 has a bottomed tubular shape whose front is open and rear is closed. The motor housing portion 21 houses the motor 6. The motor housing portion 21 houses the fan 12 and a part of a gear case 38. Screw bosses 2H are provided in the motor housing portion 21.

The grip portion 22 extends downward from the motor housing portion 21. The grip portion 22 is disposed downward of the motor housing portion 21. The grip portion 22 is disposed downward of the hammer case 3. An upper portion of the grip portion 22 is provided across the motor housing portion 21 and the hammer case 3 in the front-rear direction. The grip portion 22 is gripped by a user. The trigger lever 14 is provided in an upper portion of the grip portion 22. The trigger lever 14 is disposed downward of the motor housing portion 21.

The prop 24 is disposed forward of the grip portion 22. The prop 24 is disposed at a position away from the grip portion 22 on the front side. A space between the grip portion 22 and the prop 24 is a space in which fingers gripping the grip portion 22 are placed. The prop 24 extends below the hammer case 3. The prop 24 is disposed directly below the light emitter unit 16. The prop 24 is hollow. An upper end of the prop 24 is open. A lead wire electrically connected to the light emitter unit 16 passes the inside of the prop 24. The prop 24 may extend below the motor housing portion 21. The prop 24 may not be provided.

The battery holding portion 23 is disposed below the grip portion 22. A battery pack 80 that supplies power to the motor 6 is detachable from the battery holding portion 23. The battery holding portion 23 is connected to the grip portion 22 and the prop 24. The battery holding portion 23 is connected to a lower end of the grip portion 22. The battery holding portion 23 is connected to a lower end of the prop 24. In each of the front-rear direction and a left-right direction, an outer dimension of the battery holder 23 is larger than an outer dimension of the grip portion 22. The battery holding portion 23 extends forward from directly below the grip portion 22. The battery holding portion 23 is connected to the lower end of the prop 24 at a front end.

The motor housing portion 21 has intake ports 21A. The motor housing portion 21 has exhaust ports 21B. Air in an external space of the housing 2 flows into an internal space of the housing 2 via the intake ports 21A. Air in the internal space of the housing 2 flows out to the external space of the housing 2 via the exhaust ports 21B. The gear case 38 is connected to the front portion of the motor housing portion 21.

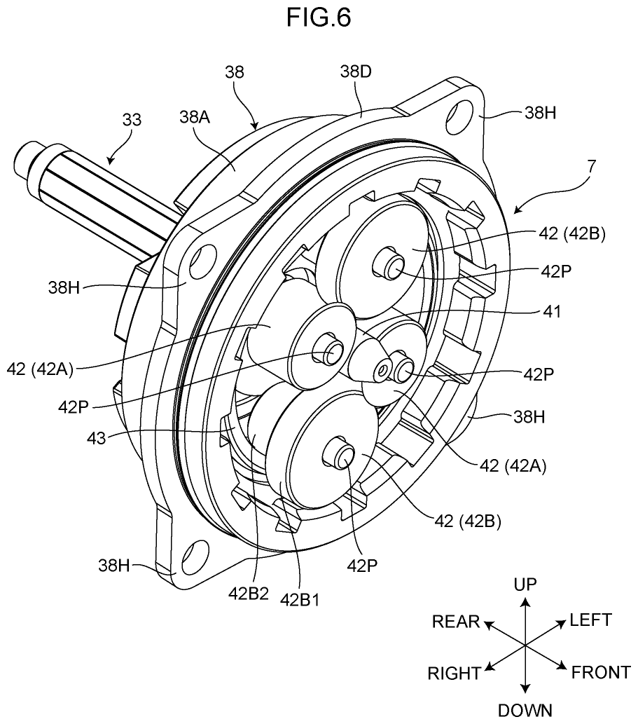

FIG. 6 is a perspective view illustrating the gear case 38 and the speed reduction mechanism 7 viewed from a front side. The gear case 38 houses the speed reduction mechanism 7. As illustrated in FIG. 5, the gear case 38 houses a rotor bearing 40 and a spindle bearing 44. The gear case 38 includes a tubular portion 38A extending in the front-rear direction, a bottom plate 38B, a holding tubular portion 38C, and a flange 38D. The tubular portion 38A has a substantially cylindrical shape. The tubular portion 38A surrounds the speed reduction mechanism 7. The bottom plate 38B extends to the radial inner side from a rear end of the tubular portion 38A. The holding tubular portion 38C is connected to an end on the radial inner side of the bottom plate 38B and extends forward. An outer diameter of the holding tubular portion 38C is smaller than an inner diameter of the tubular portion 38A. The holding tubular portion 38C is disposed inside the tubular portion 38A. The holding tubular portion 38C holds the rotor bearing 40. A rotor 27 is inserted into the holding tubular portion 38C. The spindle bearing 44 is disposed between an outer periphery of the holding tubular portion 38C and an inner periphery of the tubular portion 38A. The speed reduction mechanism 7 is disposed in a space on the front side of the holding tubular portion 38C inside the tubular portion 38A. The flange 38D extends to the radial outer side from a front end of the tubular portion 38A. The flange 38D is provided with screw bosses 38H (see FIG. 6). The gear case 38 is made of metal. In the embodiment, the gear case 38 is made of aluminum.

The hammer case 3 houses the spindle 8. The hammer case 3 houses a hammer 47. The hammer case 3 houses the impact mechanism 9 including the hammer 47. The hammer case 3 houses a part of the anvil 10. The hammer case 3 is made of metal. In the embodiment, the hammer case 3 is made of aluminum. The hammer case 3 is cylindrical. In the embodiment, the hammer case 3 has a cylindrical shape.

The hammer case 3 includes a rear tubular portion 3A, a front tubular portion 3B, a front surface portion 3C, and screw bosses 3H. The front tubular portion 3B is disposed forward of the rear tubular portion 3A. An outer diameter of the rear tubular portion 3A is larger than an outer diameter of the front tubular portion 3B. An inner diameter of the rear tubular portion 3A is larger than an inner diameter of the front tubular portion 3B. The front surface portion 3C forms a front end surface of the hammer case 3. The front surface portion 3C extends to the radial inner side from the front end of the rear tubular portion 3A. The front surface portion 3C is disposed so as to connect the front end of the rear tubular portion 3A and a rear end of the front tubular portion 3B. The front surface portion 3C has an annular shape. The front tubular portion 3B is disposed so as to protrude forward from the front surface portion 3C.

The hammer case 3 is disposed forward of the motor housing portion 21. The hammer case 3 is connected to the front of the gear case 38. The motor housing portion 21 and the gear case 38 are fixed to a rear portion of the hammer case 3 with the screws 5. Each of the screws 5 is inserted from rearward of the screw boss 2H into an opening provided in the screw boss 2H and an opening provided in the screw boss 38H, and then inserted into a screw hole provided in the screw boss 3H. In the circumferential direction, four screw bosses 2H, four screw bosses 38H, and four screw bosses 3H are provided. In the circumferential direction, four screws 5 are provided. The hammer case 3, the gear case 38, and the motor housing portion 21 are fixed to each other by the screws 5.

At least a part of a rear of the gear case 38 is housed in the motor housing portion 21. At least a part of the front of the gear case 38 is housed in the hammer case 3. The hammer case 3 is fixed to the housing 2 in the front-rear direction by the screws 5. The hammer case 3 is disposed on an upper surface of the grip portion 22.

The motor 6 is a power source of the impact tool 1. The motor 6 generates a rotational force. The motor 6 is an electric motor. The motor 6 is an inner rotor type brushless motor. The motor 6 includes the rotor 27 that is rotatable about the rotation axis AX extending in the front-rear direction, and a stator 26 to rotate the rotor 27. The stator 26 is supported by the motor housing portion 21. At least a part of the rotor 27 is disposed inside the stator 26. The rotor 27 rotates with respect to the stator 26.

The stator 26 includes a stator core 28, a front insulator 29, a rear insulator 30, and coils 31.

The stator core 28 is disposed to the radial outer side of the rotor 27. The stator core 28 includes a plurality of stacked steel plates. The steel plate is a metal plate containing iron as a main component. The stator core 28 is cylindrical. The stator core 28 includes a plurality of teeth that respectively support the coils 31.

The front insulator 29 is provided at the front of the stator core 28. The rear insulator 30 is provided at the rear portion of the stator core 28. Each of the front insulator 29 and the rear insulator 30 is an electric insulating member made of synthetic resin. The front insulator 29 is disposed so as to cover a part of surfaces of the teeth. The rear insulator 30 is disposed so as to cover a part of the surfaces of the teeth.

The coils 31 are mounted on the stator core 28 via the front insulator 29 and the rear insulator 30. The coils 31 are disposed around the respective teeth of the stator core 28 via the front insulator 29 and the rear insulator 30. The coils 31 and the stator core 28 are electrically insulated by the front insulator 29 and the rear insulator 30.

The rotor 27 rotates about the rotation axis AX. The rotor 27 includes a rotor core 32, a rotor shaft 33, and a rotor magnet 34.

Each of the rotor core 32 and the rotor shaft 33 is made of steel. In the embodiment, the rotor core 32 and the rotor shaft 33 are integrated. The rotor core 32 and the rotor shaft 33 may be separated from each other. The front of the rotor shaft 33 protrudes forward from a front end surface of the rotor core 32. The rear of the rotor shaft 33 protrudes rearward from a rear end surface of the rotor core 32.

The rotor magnet 34 is fixed to the rotor core 32. The rotor magnet 34 has a flat plate shape. The rotor magnet 34 is disposed inside the rotor core 32.

The rotor shaft 33 is provided with a balancer 35. The balancer 35 is a weight made of metal such as brass, and is provided to adjust a weight balance of the rotor 27.

A sensor substrate 37 is attached to the rear insulator 30. The sensor substrate 37 includes an annular circuit board and a magnetic sensor supported by the circuit board. The magnetic sensor detects a position of the rotor magnet 34 to detect a position of the rotor 27 in the rotation direction.

The rear of the rotor shaft 33 is rotatably supported by a rotor bearing 39. The front of the rotor shaft 33 is rotatably supported by the rotor bearing 40. The rotor bearing 39 is held by a rear plate 21C of the motor housing portion 21. The rotor bearing 40 is held by the gear case 38. The front end of the rotor shaft 33 passes through the holding tubular portion 38C of the gear case 38 and is connected to the speed reduction mechanism 7.

In one example, the rotor bearing 40 has a diameter (outer diameter) of 22.0 mm. In one example, the rotor bearing 40 has a length (front-rear dimension) of 6.0 mm.

A pinion gear 41 is provided at the front end of the rotor shaft 33. The pinion gear 41 is connected to at least a part of the speed reduction mechanism 7. The rotor shaft 33 is connected to the speed reduction mechanism 7 via the pinion gear 41.

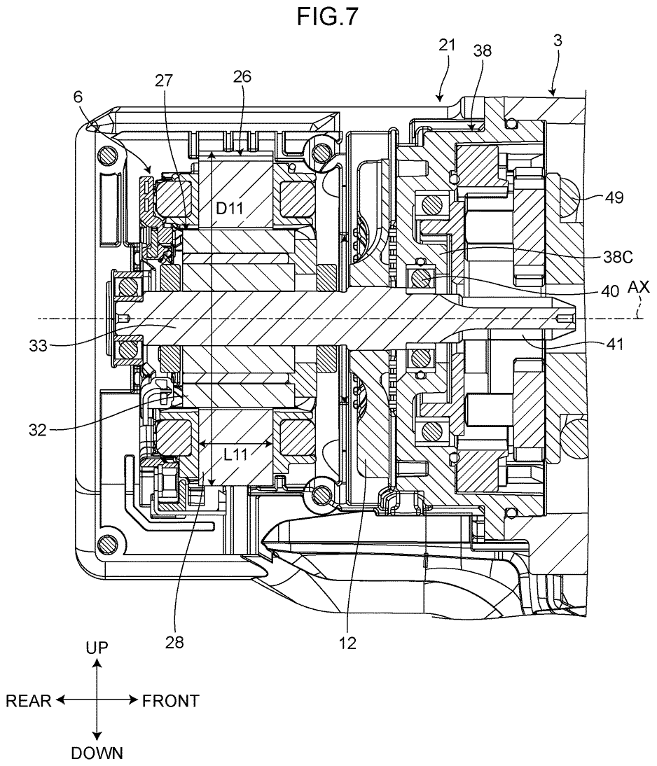

FIG. 7 is a cross-sectional view illustrating an inside of the motor housing portion 21 of the impact tool 1 according to the embodiment. In the embodiment, a nominal diameter D11 of the motor 6 is 50 mm or more. In another example, the nominal diameter of the motor 6 is 68 mm or more. In yet another example, the nominal diameter of the motor 6 is 80 mm or more. Specifically, the nominal diameter D11 of the motor 6 is an outer diameter of the stator core 28. In the embodiment, a stacking thickness L11 of the stator 26 is 20 mm or more. In another example, the stacking thickness of the stator 26 is 30 mm or more. In still another example, the stacking thickness of the stator 26 is 35.0 mm or more. Specifically, the stacking thickness L11 of the stator 26 is a length along the rotation axis AX of the stator core 28. For example, the motor 6 is a BL52-35 motor, that is, a brushless motor having the nominal diameter of 52 mm and the stacking thickness of the stator 26 of 35 mm. A combination of the nominal diameter and the stacking thickness of the motor 6 may be a combination different from the above specific example, and includes configurations within a range of ±2 mm for each of the nominal diameter and the stacking thickness.

The speed reduction mechanism 7 transmits the rotational force of the motor 6 to the spindle 8 and the anvil 10. The speed reduction mechanism 7 is housed in the gear case 38. The speed reduction mechanism 7 includes a plurality of gears. The speed reduction mechanism 7 is disposed forward of the motor 6. The speed reduction mechanism 7 connects the rotor shaft 33 and the spindle 8. The gears of the speed reduction mechanism 7 are driven by the rotor 27. The speed reduction mechanism 7 transmits the rotation of the rotor 27 to the spindle 8. The speed reduction mechanism 7 rotates the spindle 8 at a rotational speed lower than a rotational speed of the rotor shaft 33. The speed reduction mechanism 7 includes a planetary gear mechanism.

As illustrated in FIG. 6, the speed reduction mechanism 7 includes a plurality of planetary gears 42 arranged around the pinion gear 41 and an internal gear 43 arranged around the plurality of planetary gears 42. Each of the pinion gear 41, the planetary gears 42, and the internal gear 43 is housed in the gear case 38. The planetary gears 42 include a first planetary gear 42A and a second planetary gear 42B. The first planetary gear 42A engages with the pinion gear 41 and a first gear 42B1 of the second planetary gear 42B. The second planetary gear 42B includes the first gear 42B1 and a second gear 42B2 at different positions in the axial direction. The second planetary gear 42B engages with the internal gear 43 at the second gear 42B2. The internal gear 43 has an annular shape and engages with the second gear 42B2. The internal gear 43 is fixed to the gear case 38. The internal gear 43 is always non-rotatable with respect to the gear case 38. Each of the planetary gears 42 (first planetary gear 42A and second planetary gear 42B) is rotatably supported by the spindle 8 via pins 42P. The spindle 8 is rotated by the planetary gears 42.

When the rotor shaft 33 rotates by driving the motor 6, the pinion gear 41 rotates, and the first planetary gear 42A and the second planetary gear 42B revolve around the pinion gear 41. The second planetary gear 42B revolves while engaging with inner teeth of the internal gear 43. Due to the revolution of each of the planetary gears 42, the spindle 8 connected to each of the planetary gears 42 via the pins 42P rotates at a rotational speed lower than the rotational speed of the rotor shaft 33.

The speed reduction mechanism 7 has a predetermined speed reduction ratio between the pinion gear 41 and the spindle 8. The speed reduction ratio of the speed reduction mechanism 7 is, for example, 10 or more and 18 or less. In one example, the speed reduction ratio of the speed reduction mechanism 7 is 12.00 or more. In another example, the speed reduction ratio of the speed reduction mechanism 7 is 14.00 or more. In still another example, the speed reduction ratio of the speed reduction mechanism 7 is 15.00 or more. In one example, the speed reduction ratio of the speed reduction mechanism 7 is 17.50 or less. In another example, the speed reduction ratio of the speed reduction mechanism 7 is 17.00 or less. In still another example, the speed reduction ratio of the speed reduction mechanism 7 is 16.50 or less.

As illustrated in FIG. 5, the impact mechanism 9 is driven by the motor 6. The rotational force of the motor 6 is transmitted to the impact mechanism 9 via the speed reduction mechanism 7. The impact mechanism 9 impacts the anvil 10 in the rotation direction with the rotational force of the motor 6. The impact mechanism 9 includes the spindle 8, the hammer 47, balls 48, and a spring 49. The impact mechanism 9 is housed in the hammer case 3.

The hammer case 3 houses the impact mechanism 9. The hammer case 3 houses at least a part of the spindle 8, the hammer 47, the balls 48, the spring 49, and a part of the anvil 10 therein. The hammer case 3 houses a part of the hammer 47 and the anvil 10 while causing a tip tool holder 19 to protrude forward. In other words, the front tubular portion 3B is formed on the front surface of the hammer case 3. The distal end of the anvil 10 passes through the front tubular portion 3B and protrudes forward from the front surface of the hammer case 3. As a result, the tip tool holder 19 disposed at the distal end of the anvil 10 is disposed forward of the hammer case 3.

Details of the impact mechanism 9 will be described later.

The fan 12 is rotated by the rotational force of the motor 6. The fan 12 is disposed forward of the stator 26 of the motor 6. The fan 12 generates an air flow for cooling the motor 6. The fan 12 is fixed to the rotor 27. The fan 12 is fixed to the front of the rotor shaft 33. The fan 12 is disposed between the rotor bearing 40 and the stator 26. The fan 12 is rotated by the rotation of the rotor 27. When the rotor shaft 33 rotates, the fan 12 rotates together with the rotor shaft 33. When the fan 12 rotates, air in the external space of the housing 2 flows into the internal space of the housing 2 via the intake ports 21A. The air flowing into the internal space of the housing 2 flows through the internal space of the housing 2 to cool the motor 6. The air flowing through the internal space of the housing 2 flows out to the external space of the housing 2 via the exhaust ports 21B when the fan 12 rotates.

As illustrated in FIG. 4, the battery pack 80 is attached to the battery holding portion 23. The battery pack 80 functions as a power source of the impact tool 1. The battery pack 80 includes a secondary battery. In the present embodiment, the battery pack 80 includes a rechargeable lithium ion battery. By being attached to the battery holding portion 23, the battery pack 80 can supply power to the impact tool 1. Each of the motor 6 and the light emitter unit 16 is driven with electric power supplied from the battery pack 80.

The rated voltage of the battery pack 80 is 14.4 V or more. The rated voltage of the battery pack 80 may be 14.4 V, 18 V, 36 V, or 72 V.

The battery pack 80 has a release switch 81. The release switch 81 is disposed on the front of an upper surface of the battery pack 80. The release switch 81 is a push button. The release switch 81 moves downward by being pressed downward. The release switch 81 is biased upward by a biasing member (not illustrated). The release switch 81 includes an engagement hook 82 protruding upward from an upper surface of the battery pack 80 at a position of an upper movement limit, and a finger rest 84 to be pressed downward by a user.

The battery holding portion 23 has an engagement recess 23A that comes into contact with the engagement hook 82. The engagement recess 23A is recessed upward from a lower surface of the battery holding portion 23. When the engagement hook 82 enters the inside of the engagement recess 23A, the battery holding portion 23 is engaged such that the battery pack 80 will not be detached. When the release switch 81 is pressed down by pressing the finger rest 84 and the engagement hook 82 is disengaged downward from the engagement recess 23A, the battery pack 80 can be removed from the battery holding portion 23.

The battery holding portion 23 includes a controller 17 that controls the light emitter unit 16 and an interface panel 18. The controller 17 includes a computer system. The controller 17 outputs control commands for controlling the motor 6. The controller 17 includes a circuit board on which a plurality of electronic components are mounted. Examples of the electronic components mounted on the circuit board include a processor such as a central processing unit (CPU), a nonvolatile memory such as a read only memory (ROM) or a storage, a volatile memory such as a random access memory (RAN), a transistor, a capacitor, and a resistor. The controller 17 sets a driving condition of the motor 6 based on the operation of the interface panel 18.

The interface panel 18 is provided in the battery holding portion 23. The interface panel 18 includes an operation device and a display device. The interface panel 18 has a plate shape. The operation device includes an operation button. Examples of the display device include a segment display including a plurality of segment light emitters, a flat panel display such as a liquid crystal display, and an indicator type display in which a plurality of light emitting diodes are arranged.

The trigger lever 14 is provided on the grip portion 22. The trigger lever 14 is operated to start the motor 6. Driving and stopping of the motor 6 are switched by operating the trigger lever 14. The trigger lever 14 is disposed between the grip portion 22 and the prop 24 in the front-rear direction. The trigger lever 14 is disposed forward of the motor housing portion 21. The trigger lever 14 is disposed downward of the motor housing portion 21 on the grip portion 22. The trigger lever 14 is disposed directly below the hammer case 3. The trigger lever 14 is disposed between the motor housing portion 21 and the battery holding portion 23 in the up-down direction. A trigger signal is generated by operating the trigger lever 14. The controller 17 switches between driving and stopping of the motor 6 based on the trigger signal.

The forward/reverse switching lever 15 is provided at the upper portion the grip portion 22. The forward/reverse switching lever 15 is operated by the user. When the forward/reverse switching lever 15 is operated, the rotation direction of the motor 6 is switched from one of the forward rotation direction and the reverse rotation direction to the other. The rotation direction of the spindle 8 is switched by switching the rotation direction of the motor 6.

The light emitter unit 16 emits illumination light. The light emitter unit 16 illuminates the anvil 10 and the periphery of the anvil 10 with the illumination light. The light emitter unit 16 illuminates a front end side of the anvil 10 with the illumination light.

The light emitter unit 16 is disposed at the front portion of the hammer case 3. The light emitter unit 16 is disposed on the front surface portion 3C of the hammer case 3. The light emitter unit 16 is disposed around the front tubular portion 3B. The light emitter unit 16 is formed so as to surround the anvil 10. In the embodiment, the light emitter unit 16 has an annular shape surrounding the anvil 10.

The light emitter unit 16 includes a plurality of light emitters 52. The light emitters 52 are light emitting diode (LED) elements. In the embodiment, the light emitter unit 16 includes a chip on board light emitting diode (COB LED) light (hereinafter, referred to as COB light 50), as illustrated in FIG. 5.

The COB light 50 includes a substrate 51 and a plurality of light emitters 52. Examples of the substrate 51 include an aluminum substrate, a glass cloth base material epoxy resin substrate (FR-4 substrate), and a composite base material epoxy resin substrate (CEM-3 substrate). The light emitters 52 are mounted on a surface of the substrate 51. The light emitters 52 and the substrate 51 are connected via a gold wire (not illustrated). The gold wire connects the light emitters 52 to each other. The light emitters 52 are surrounded by a bank. A phosphor is disposed in a compartment space surrounded by the bank. The light emitters 52 are covered with the phosphor. A pair of electrodes (not illustrated) are arranged on a surface (front surface) or a rear surface (back surface) of the substrate 51 outside the bank. One of the pair of electrodes is a positive electrode, and the other electrode is a negative electrode. The pair of electrodes are connected to the controller 17 via lead wires, respectively. The electric power output from the battery pack 80 is supplied to the electrodes via the lead wires. The electric power supplied to the electrodes is supplied to the light emitters 52 via the substrate 51 and the gold wire. The light emitters 52 emit light with the electric power supplied from the battery pack 80.

The COB light 50 has an annular shape. The COB light 50 is disposed around an anvil shaft 10C via the front tubular portion 3B. The plurality of light emitters 52 are disposed in the rotation direction around the anvil 10. The number of light emitters 52 is not limited as long as it is plural. For example, 24 light emitters 52 are disposed at equal intervals in the circumferential direction of the front tubular portion 3B.

The light emitter unit 16 includes an optical member 55. The optical member 55 is connected to the COB light 50. The optical member 55 is fixed to the substrate 51. The optical member 55 is made of polycarbonate resin. In the embodiment, the optical member 55 is made of polycarbonate resin containing a white diffusion material. The optical member 55 is milky white. The optical member 55 transmits at least a part of light emitted from the COB light 50. Light transmittance of the optical member 55 is, for example, 40% or more and 70% or less. The optical member 55 diffuses the light emitted from the plurality of light emitters 52. The optical member 55 is disposed to cover front sides of the light emitters 52. The optical member 55 is continuous across the light emitters 52. The optical member 55 has an annular shape.

The hammer case 3 supports the light emitter unit 16 on the front surface portion 3C. The hammer case 3 has an installation portion 3D that houses the light emitter unit 16. The installation portion 3D is disposed on the front surface portion 3C of the hammer case 3. The installation portion 3D is disposed between the front tubular portion 3B and an outer periphery of the front surface portion 3C. The installation portion 3D is annular and recessed. The installation portion 3D houses at least a part of the light emitter unit 16.

The front tubular portion 3B is provided with a snap ring groove 3J. The snap ring groove 3J is provided on the front side of the light emitter unit 16. A snap ring 56 is disposed in the snap ring groove 3J. The snap ring 56 functions as a retainer to prevent the light emitter unit 16 from coming off to the front side. The snap ring 56 supports the optical member 55 from the front side.

The hammer case 3 has a wall 3F surrounding the outer periphery of the light emitter unit 16. The wall 3F protrudes forward from the front surface portion 3C of the hammer case 3. The wall 3F is provided circumferentially along an outer peripheral edge of the front surface portion 3C of the hammer case 3. A region of the front surface portion 3C between the front tubular portion 3B and the wall 3F forms the installation portion 3D.

A buffer member 57 is disposed between the hammer case 3 and the light emitter unit 16. The buffer member 57 is disposed behind the COB light 50. The buffer member 57 is elastic and is made of, for example, a rubber material. The buffer member 57 protects the substrate 51 and the optical member 55 made of a resin material from contact with the hammer case 3 that is a metal vibrating body. The snap ring 56 may function as a retainer to prevent the buffer member 57 from coming off.

The impact tool 1 includes a first protective cover 61 and a second protective cover 62.

As illustrated in FIGS. 1 to 4, the first protective cover 61 is disposed on the outer periphery of the front surface portion 3C of the hammer case 3. The first protective cover 61 covers the wall 3F and the outer periphery of the front surface 16A of the light emitter unit 16. The first protective cover 61 has an annular shape.

The second protective cover 62 is disposed on an inner peripheral portion of the front surface portion 3C of the hammer case 3. That is, the second protective cover 62 is disposed in a portion of the front tubular portion 3B of the front surface portion 3C. The second protective cover 62 covers the front tubular portion 3B and the inner peripheral portion of the front surface 16A of the light emitter unit 16. The second protective cover 62 covers the snap ring 56 attached to the front tubular portion 3B. The second protective cover 62 has an annular shape.

The first protective cover 61 and the second protective cover 62 are made of an elastic body such as a rubber material. The first protective cover 61 and the second protective cover 62 have a light shielding property. The first protective cover 61 and the second protective cover 62 are, for example, black. The inner periphery of the first protective cover 61 and the outer periphery of the second protective cover 62 are concentric. The front surface 16A of the light emitter unit 16 is exposed to the front side in a circular annular portion between the first protective cover 61 and the second protective cover 62. This annular portion serves as a light emission region from the light emitter unit 16 to the outside. The light emitted from the light emitter unit 16 is narrowed to a range directed forward from the annular portion.

The first protective cover 61 and the second protective cover 62 prevent contact of an obstacle with the light emitter unit 16 during use of the impact tool 1. The first protective cover 61 and the second protective cover 62 protect an external object to prevent damage occurring when the front surface portion 3C or the front tubular portion 3B of the metal hammer case 3 collides with the external object during use of the impact tool 1. The first protective cover 61 and the second protective cover 62 prevents light leakage, light diffusion to an excessive wide angle, and unnecessary surface reflection of the hammer case 3 including the front tubular portion 3B, by limiting the light emission region of the light emitter unit 16 to the annular portion.

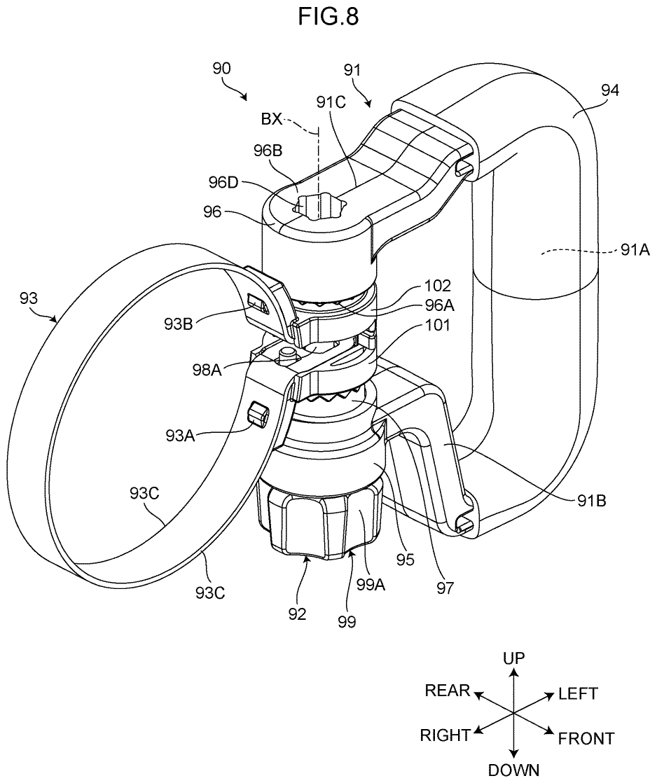

FIG. 8 is a perspective view illustrating a side handle 90 according to the embodiment. In the impact tool 1, the side handle 90 is detachable. The side handle 90 includes a handle base 91, a tightening mechanism 92 provided on the handle base 91, and a band 93 for tightening the impact tool 1. The side handle 90 is detachably fixed to the impact tool 1 by tightening the band 93 surrounding a predetermined location of the impact tool 1 by the tightening mechanism 92. FIGS. 1 to 4 illustrate a state in which only the band 93 of the side, and illustration of the handle base 91 and the tightening mechanism 92 is omitted for the sake of convenience.

As illustrated in FIGS. 1 to 3, the impact tool 1 includes a band attachment portion 70 to which the band 93 of the side handle 90 is attached. The band attachment portion 70 is provided in the circumferential direction along an outer periphery of the hammer case 3. The band attachment portion 70 is provided in a manner to pass between the grip portion 22 and the prop 24. The band attachment portion 70 is disposed on the front side of the grip portion 22. The band attachment portion 70 is disposed behind the prop 24. The side handle 90 is detachable from the hammer case 3. The side handle 90 is fixed to the impact tool 1 by surrounding and tightening the hammer case 3 and the housing 2 with the band 93. When the side handle 90 is attached, the light emitter unit 16 is positioned on the front side of the side handle 90.

The handle base 91 includes a columnar portion 91A, a first arm 91B, and a second arm 91C. The handle base 91 is made of resin. The first arm 91B extends in a lateral direction from one end of the columnar portion 91A. The second arm 91C extends from the other end of the columnar portion 91A in the same direction as the first arm 91B. The handle base 91 has a C-shape by the columnar portion 91A, the first arm 91B, and the second arm 91C. The columnar portion 91A is provided with a handle grip 94 made of resin. The handle grip 94 is a tubular member surrounding the periphery of the columnar portion 91A, and is held by the user's hand. By attaching the side handle 90 to the impact tool 1, the user can hold the grip portion 22 of the housing 2 with one hand while holding the handle grip 94 with the other hand. Thus, the user can stably hold the impact tool 1.

The handle base 91 holds the tightening mechanism 92 and the band 93. The handle base 91 holds the tightening mechanism 92 by the first arm 91B and the second arm 91C. A first holding portion 95 is provided at a distal end of the first arm 91B. A second holding portion 96 is provided at a distal end of the second arm 91C.

The first holding portion 95 has a cylindrical shape. The first holding portion 95 holds a cam member 97. The cam member 97 has a cam engagement surface facing the second holding portion 96. The cam engagement surface is an engagement surface of an uneven pattern. The cam member 97 has an annular shape. A shaft of a bolt 98A is inserted into the cam member 97.

The second holding portion 96 has a tubular shape. The second holding portion 96 has an inner surface 96A facing the first holding portion 95, and an outer surface 96B facing a direction opposite to the first holding portion 95. The inner surface 96A is an engagement surface of an uneven pattern. The outer surface 96B is provided with a recessed bolt holding portion 96D that houses a head of the bolt 98A. The bolt holding portion 96D has an inner surface shape corresponding to a tool hook shape of the head of the bolt 98A, and is engaged with the bolt 98A. As a result, the bolt 98A is held inside the bolt holding portion 96D in a non-rotatable manner.

The tightening mechanism 92 includes the bolt 98A, the cam member 97, and a tightening knob 99. The bolt 98A extends along a central axis line BX and is across the first holding portion 95 and the second holding portion 96. The bolt 98A penetrates the second holding portion 96, the cam member 97, and the first holding portion 95 from the outer surface 96B of the second holding portion 96 and engages with the tightening knob 99.

The tightening knob 99 is disposed on the first holding portion 95. The tightening knob 99 can hold and rotate a held portion 99A. The tightening knob 99 holds a nut that engages with a screw at a distal end of the bolt 98A. The tightening knob 99 and the nut rotate together. When the tightening knob 99 is rotated about the central axis line BX, the nut advances and retracts along the screw of the bolt 98A. As a result, the tightening knob 99 moves along the bolt 98A.

The band 93 is a C-shaped belt-like member. The band 93 is made of metal. A first attachment portion 101 and a second attachment portion 102 are provided at one end and the other end of the band 93, respectively. The first attachment portion 101 and the second attachment portion 102 are made of resin. The first attachment portion 101 and the second attachment portion 102 are annular, and the bolt 98A penetrates therethrough. The first attachment portion 101 has an engagement surface of an uneven pattern and is engaged with the cam engagement surface of the cam member 97. The second attachment portion 102 has an engagement surface of an uneven pattern, and is engaged with a cam engagement surface of the inner surface 96A of the second holding portion 96. When the first attachment portion 101 and the second attachment portion 102 are engaged with the cam member 97 and the second holding portion 96, respectively, a relative angle of the band 93, with respect to the handle base 91 in the rotation direction around the central axis line BX, is fixed.

The band 93 is held by the handle base 91 by insertion of the bolt 98A into the first attachment portion 101 and the second attachment portion 102. Since the C-shaped band 93 is connected to the bolt 98A at the first attachment portion 101 and the second attachment portion 102 at both ends, the band 93 becomes an annular shape substantially surrounding the entire circumference of the band attachment portion 70.

A protrusion 93A and a protrusion 93B are provided on an inner peripheral surface of the band 93. The protrusion 93A and the protrusion 93B have a V-like protruded shape. The protrusion 93A and the protrusion 93B are meshed and engaged with an outer peripheral surface of the band attachment portion 70. The protrusion 93A and the protrusion 93B prevent the band 93 from moving relative to the band attachment portion 70 around the rotation axis AX along the outer periphery of the band attachment portion 70.

At the time of mounting the side handle 90, the user rotates the tightening knob 99 in a loosening direction to release the engagement between the nut of the tightening knob 99 and the bolt 98A, and pulls out the bolt 98A. As a result, the band 93 and the handle base 91 are separated. The user places the band 93 so as to surround the periphery of the band attachment portion 70. In a state where the band 93 is placed around the band attachment portion 70, the user attaches the bolt 98A so as to pass through the second holding portion 96, the second attachment portion 102, the first attachment portion 101, the cam member 97, and the tightening knob 99, and meshes the bolt 98A with the nut of the tightening knob 99. The user rotates the tightening knob 99 in a tightening direction to move the tightening knob 99 along the central axis line BX of the bolt 98A. The tightening knob 99 moves in a direction approaching the second holding portion 96. As the tightening knob 99 moves, the cam member 97 and the first attachment portion 101 approach the second holding portion 96. As a distance between the first attachment portion 101 and the second attachment portion 102 is reduced, the inner diameter of the band 93 is reduced. By reduction of the inner diameter of the band 93, the band 93 tightens the impact tool 1 at the band attachment portion 70. The side handle 90 is fixed to the impact tool 1 by the tightening force of the band 93. To remove the side handle 90, the tightening knob 99 is rotated in the loosening direction in the same manner as at the time of attachment, and the bolt 98A is removed.

### Impact Mechanism

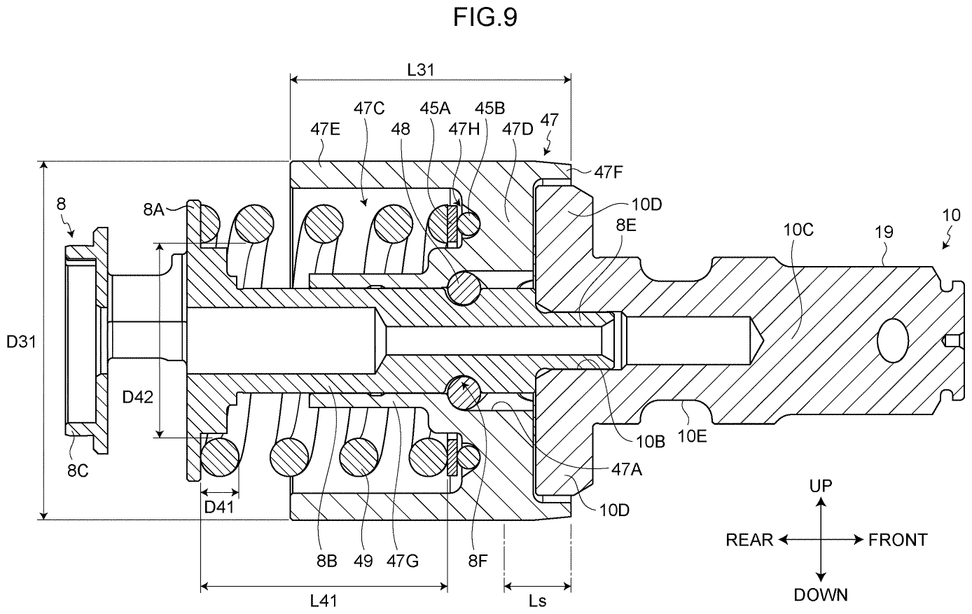

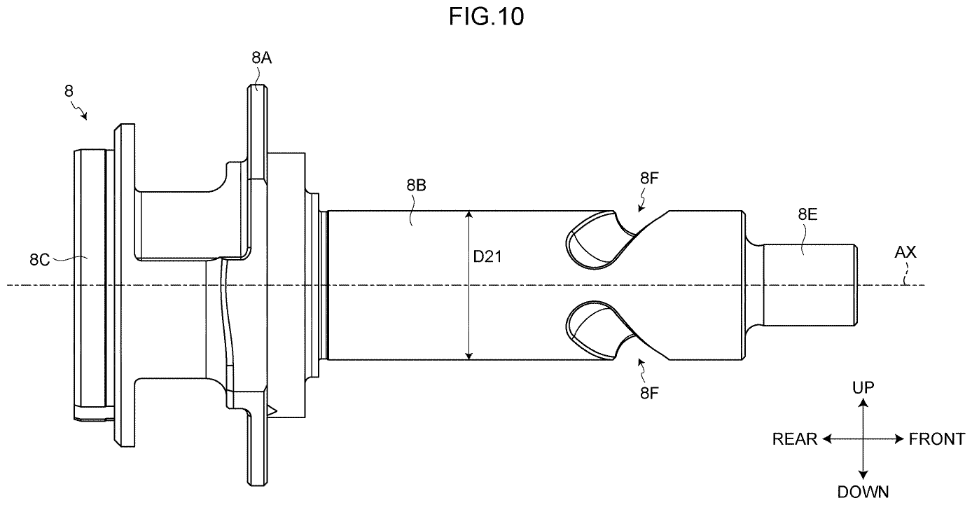

Next, a detailed structure of the impact mechanism 9 will be described. FIG. 9 is a cross-sectional view illustrating the impact mechanism 9 according to the embodiment. FIG. 10 is a side view illustrating the spindle 8 according to the embodiment.

As illustrated in FIG. 5, the spindle 8 extends along the rotation axis AX. The spindle 8 is disposed forward of at least a part of the motor 6. The spindle 8 is disposed forward of the stator 26. At least a part of the spindle 8 is disposed forward of the rotor 27. At least a part of the spindle 8 is disposed forward of the speed reduction mechanism 7. The spindle 8 is rotated by the rotor 27. In other words, the spindle 8 is rotated by the rotational force of the motor 6. The spindle 8 is rotated by the rotational force of the rotor 27 transmitted via the speed reduction mechanism 7.

The spindle 8 includes a flange 8A and a spindle shaft 8B protruding forward from the flange 8A. The planetary gears 42 are rotatably supported by the flange 8A via the pins 42P. The rotation axis of the spindle 8 coincides with the rotation axis AX of the motor 6. The spindle 8 rotates about the rotation axis AX.

The spindle 8 is rotatably supported by the spindle bearing 44. The spindle 8 has an arc-shaped rib 8C protruding rearward from the rear of the flange 8A. The spindle bearing 44 is disposed outside the rib 8C. In the embodiment, an inner ring of the spindle bearing 44 is connected to the rib 8C, and an outer ring of the spindle bearing 44 is supported by the gear case 38.

As illustrated in FIG. 9, the spindle shaft 8B is inserted into the hammer 47. The spindle shaft 8B passes through the inside of an inner cylindrical portion 47G of the hammer 47. An outer peripheral surface of the spindle shaft 8B faces an inner peripheral surface of the inner cylindrical portion 47G of the hammer 47 in the radial direction. The spindle 8 has spindle grooves 8F. At least a part of each of the balls 48 is arranged in the corresponding spindle groove 8F. As illustrated in FIG. 10, each of the spindle grooves 8F is provided in a part of an outer peripheral surface of the spindle shaft 8B. Each of the spindle grooves 8F is inclined with respect to the rotation axis AX.

For example, the spindle shaft 8B has a diameter D21 of 22 mm or more. In one example, the spindle shaft 8B has the diameter D21 of 26 mm or more. In another example, the spindle shaft 8B has the diameter D21 of 33 mm or more. For example, the spindle shaft 8B has the diameter D21 of 49.5 mm or less.

For example, the spindle groove 8F has a lead angle of 25 degrees or more and 40 degrees or less. Note that the lead angle of the spindle groove 8F refers to an angle between an approximated straight line obtained by developing a trajectory traced by the center of the spindle groove 8F for one rotation onto a plane and then approximating the trajectory as a straight line and the front-rear direction. In one example, the spindle groove 8F has the lead angle of 27.5 degrees or more. In another example, the spindle groove 8F has the lead angle of 32 degrees or more. In one example, the spindle groove 8F has the lead angle of 37 degrees or less. In another example, the spindle groove 8F has the lead angle of 35 degrees or less.

For example, the weight of the spindle 8 is 280 g or more. In one example, the weight of the spindle 8 is 300 g or more. In another example, the weight of the spindle 8 is 340 g or more. For example, the weight of the spindle 8 is 1100 g or less. In one example, the weight of the spindle 8 is 967 g or less. In another example, the weight of the spindle 8 is 892 g or less.

For example, the spindle 8 has a moment of inertia of 65.0 kg·mm² or more. In one example, the spindle 8 has the moment of inertia of 70.0 kg·mm² or more. In another example, the spindle 8 has the moment of inertia of 80.0 kg·mm² or more. For example, the spindle 8 has the moment of inertia of 550 kg·mm² or less. In one example, the spindle 8 has the moment of inertia of 469 kg·mm² or less. In another example, the spindle 8 has the moment of inertia of 419 kg·mm² or less.

As illustrated in FIG. 5, the hammer 47 is disposed forward of the speed reduction mechanism 7. The hammer 47 is housed in the rear tubular portion 3A. The hammer 47 is disposed around the spindle shaft 8B. The hammer 47 is held by the spindle shaft 8B. The balls 48 are disposed between the spindle shaft 8B and the hammer 47. The spring 49 is supported by each of the flange 8A and the hammer 47.

FIG. 11 is a perspective view illustrating the hammer 47 according to the embodiment. As illustrated in FIGS. 9 and 11, the hammer 47 includes an annular body portion 47D, a rear outer cylindrical portion 47E protruding rearward from an outer peripheral portion of the body portion 47D, a front outer cylindrical portion 47F protruding forward from the outer peripheral portion of the body portion 47D, an inner cylindrical portion 47G protruding rearward from an inner peripheral portion of the body portion 47D, hammer grooves 47A, and hammer protrusions 47B (see FIG. 11). The body portion 47D is arranged around the spindle shaft 8B. The body portion 47D has an annular shape. Each of the rear outer cylindrical portion 47E and the inner cylindrical portion 47G protrudes rearward from the body portion 47D. A recess 47C is defined by a rear surface of the body portion 47D, an inner peripheral surface of the rear outer cylindrical portion 47E, and an outer peripheral surface of the inner cylindrical portion 47G. The recess 47C is provided so as to be recessed forward from a rear end of the hammer 47. The recess 47C has a ring shape. The hammer protrusions 47B protrudes forward from the body portion 47D. The hammer protrusion 47B protrudes to the radial inner side from an inner peripheral surface of the front outer cylindrical portion 47F. Two hammer protrusions 47B are provided. Since the rear outer cylindrical portion 47E and the front outer cylindrical portion 47F are provided, the inertial force of the hammer 47 in the rotation direction increases.

The hammer 47 is rotated by the rotational force of the motor 6. The rotational force of the motor 6 is transmitted to the hammer 47 via the speed reduction mechanism 7 and the spindle 8. The hammer 47 is rotated by the spindle 8. The hammer 47 is rotatable together with the spindle 8 with the rotational force of the spindle 8 rotated by the motor 6. The rotation axis of the hammer 47, the rotation axis of the spindle 8, and the rotation axis AX of the motor 6 coincide with each other. The hammer 47 rotates about the rotation axis AX. The hammer 47 moves with respect to the spindle 8. The hammer 47 reciprocates along the rotation axis AX. That is, the hammer 47 moves relative to the spindle 8 in the front-rear direction. The hammer 47 rotates about the rotation axis AX while moving relative to the spindle 8 in the front-rear direction to impact the anvil 10 in the rotation direction. The hammer protrusions 47B serve as contact points when impacting the anvil 10.

In the embodiment, the weight of the hammer 47 is 800 g or more. In one example, the weight of the hammer 47 is 900 g or more. In another example, the weight of the hammer 47 is 950 g or more. In yet another example, the weight of the hammer 47 is 3000 g or less. For example, the weight of the hammer 47 is 2096 g or less. In one example, the weight of the hammer 47 is 1216 g or less. In another example, the weight of the hammer 47 is 1032 g or less.

In the embodiment, the moment of inertia of the hammer 47 is 900 kg·mm² or more. In one example, the hammer 47 has the moment of inertia of 950 kg·mm² or more. In another example, the hammer 47 has the moment of inertia of 1000 kg·mm² or more. In still another example, the hammer 47 has the moment of inertia of 1100 kg·mm² or more. For example, the hammer 47 has the moment of inertia of 6000 kg·mm² or less. In one example, the hammer 47 has the moment of inertia of 4660 kg mm² or less. In another example, the hammer 47 has the moment of inertia of 1610 kg·mm² or less.

As illustrated in FIG. 9, in the embodiment, a diameter D31 of the hammer 47 is 70 mm or more, and a total length L31 of the hammer 47 is 35 mm or more. The diameter D31 of the hammer 47 is the maximum outer diameter of the hammer 47. The total length L31 of the hammer 47 is the maximum dimension in the axial direction of the hammer 47, and is a distance between a lower end and an upper end of the hammer 47. In one example, the hammer 47 has the diameter D31 of 75.0 mm or more. In another example, the hammer 47 has the diameter D31 of 83.0 mm or more. For example, the hammer 47 has the diameter D31 of 150 mm or less. In one example, the hammer 47 has the diameter D31 of 120 mm or less. In another example, the hammer 47 has the diameter D31 of 100 mm or less. In one example, the hammer 47 has the total length L31 of 40.0 mm or more. In another example, the hammer 47 has the total length L31 of 48.0 mm or more. For example, the hammer 47 has he total length L31 of 75 mm or less. In one example, the hammer 47 has the total length L31 of 63 mm or less. In another example, the hammer 47 has the total length L31 of 57 mm or less.

In the embodiment, the total length L31 of the hammer 47 is 60% or less of the diameter D31 of the hammer 47. For example, when the diameter D31 is 70 mm, the total length L31 is 42 mm or less. For example, when the diameter D31 is 75 mm, the total length L31 is 45 mm or less. For example, when the diameter D31 is 80 mm, the total length L31 is 48 mm or less.

The balls 48 are made of metal such as iron and steel. The balls 48 are disposed between the spindle shaft 8B and the hammer 47. The hammer 47 has the hammer grooves 47A. At least a part of each of the balls 48 is disposed in the corresponding hammer groove 47A. Each of the hammer grooves 47A is provided in a part of the inner surface of the inner cylindrical portion 47G. Each of the balls 48 is disposed between the corresponding spindle groove 8F and the corresponding hammer groove 47A. Each of the balls 48 can roll inside the corresponding spindle grooves 8F and inside the corresponding hammer groove 47A. The hammer 47 is movable as the balls 48 move. The spindle 8 and the hammer 47 can move relative to each other in both the axial direction and the rotation direction within a movable range defined by the spindle grooves 8F and the hammer grooves 47A.

For example, the ball 48 has a diameter of 7.1 mm or more. In one example, the ball 48 has the diameter of 7.2 mm or more. In another example, the ball 48 has the diameter of 7.9 mm or more. For example, the ball 48 has the diameter of 12.7 mm or less. In one example, the ball 48 has the diameter of 10.3 mm or less. In another example, the ball 48 has the diameter of 8.7 mm or less.

For example, the weight of the ball 48 is 1.5 g or more. In one example, the weight of the ball 48 is 1.7 g or more. In another example, the weight of the ball 48 is 2.0 g or more. For example, the weight of the ball 48 is 8.4 g or less. In one example, the weight of the ball 48 is 4.5 g or less. In another example, the weight of the ball 48 is 2.7 g or less.

For example, the ball 48 has the moment of inertia of 0.0074 kg·mm² or more. In one example, the ball 48 has the moment of inertia of 0.0080 g·mm² or more. In another example, the ball 48 has the moment of inertia of 0.0125 kg·mm² or more. For example, the ball 48 has the moment of inertia of 0.140 kg·mm² or less. In one example, the ball 48 has the moment of inertia of 0.048 kg·mm² or less. In another example, the ball 48 has the moment of inertia of 0.021 kg·mm² or less.

The spring 49 biases the hammer 47 toward the anvil 10. The spring 49 generates an elastic force that moves the hammer 47 forward. The spring 49 is a compression coil spring in which a metal wire is wound in a coil shape (i.e., a spiral shape). The spring 49 is disposed between the flange 8A and the hammer 47. The spring 49 is provided around the spindle shaft 8B. A washer 45A is provided inside the recess 47C. The washer 45A is supported by the body portion 47D via balls 45B. The ball 45B is disposed in a ball groove 47H provided on the rear surface of the body portion 47D. A rear end of the spring 49 is supported by the flange 8A. A front end of the spring 49 is disposed inside the recess 47C and is supported by the washer 45A.

The spring 49 is assembled to the impact mechanism 9 in a state of being compressed in advance. The spring 49 applies a predetermined preload forward to the hammer 47 in a state that the impact tool 1 is not in operation. In the present teachings, a length of the spring 49 (length of when the preload is generated) in the state that the impact tool 1 is not in operation is referred to as a preload length.

For example, the spring 49 has a wire diameter D41 of 5.5 mm or more. In one example, the spring 49 has the wire diameter D41 of 6.0 mm or more. In another example, the spring 49 has the wire diameter D41 of 6.5 mm or more. For example, the spring 49 has the wire diameter D41 of 13 mm or less. In one example, the spring 49 has the wire diameter D41 of 9.5 mm or less. In another example, the spring 49 has the wire diameter D41 of 7.5 mm or less.

For example, the spring 49 has a coil inner diameter D42 of 42.0 mm or more. In one example, the spring 49 has the coil inner diameter D42 of 44.0 mm or more. In another example, the spring 49 has the coil inner diameter D42 of 46.0 mm or more. For example, the spring 49 has the coil inner diameter D42 of 90 mm or less. In one example, the spring 49 has the coil inner diameter D42 of 71 mm or less. In another example, the spring 49 has the coil inner diameter D42 of 50.5 mm or less.

For example, the spring 49 has a preload length L41 of 35 mm or more. In one example, the spring 49 has the preload length L41 of 37 mm or more. In another example, the spring 49 has the preload length L41 of 41 mm or more. For example, the spring 49 has the preload length L41 of 80 mm or less. In one example, the spring 49 has the preload length L41 of 62 mm or less. In another example, the spring 49 has the preload length L41 of 48 mm or less.

For example, the spring 49 applies the preload of 500 N or more to the hammer 47. In one example, the spring 49 applies the preload of 600 N or more to the hammer 47. In another example, the spring 49 applies the preload of 705 N or more to the hammer 47. For example, the spring 49 applies the preload of 1500 N or less to the hammer 47. In one example, the spring 49 applies the preload of 1175 N or less to the hammer 47. In another example, the spring 49 applies the preload of 870 N or less to the hammer 47.

In the embodiment, a spring constant of the spring 49 is 80 N/mm or more. In one example, the spring 49 has the spring constant of 85 N/mm or more. In another example, the spring 49 has the spring constant of 101 N/mm or more. For example, the spring constant of the spring 49 is 250 N/mm or less. In one example, the spring 49 has the spring constant of 234 N/mm or less. In another example, the spring 49 has the spring constant of 193 N/mm or less.

In the embodiment, the impact mechanism 9 includes one spring 49. A plurality of springs 49 may be provided in the impact mechanism 9. The impact tool 1 may include three springs, for example, as in the impact tool disclosed in JP 2023-61297 A. In this case, a first spring constantly biases the hammer 47. A second spring biases the hammer 47 when the hammer 47 retreats to a predetermined position. A third spring is provided between the second spring and the hammer 47. The third spring suppresses movement of the second spring in a state that the second spring does not bias the hammer 47. In the case of this example, the first spring and the second spring have the spring constant in a range of the spring 49 described above. In one example, the spring constant of the second spring is greater than the spring constant of the first spring. The preload and the spring constant of the third spring may be sufficiently smaller than those of the first spring and the second spring. The second spring is provided in a state of substantially natural length. The substantially natural length means that a compressive load (a pre-compression amount by the compressive load) applied from the third spring can be ignored. In addition, the impact tool 1 may include, for example, two springs.

As illustrated in FIG. 5, the anvil 10 is an output portion of the impact tool 1 operated by the rotational force of the motor 6. The anvil 10 is rotated by the rotational force of the motor 6. The anvil 10 is disposed forward of the hammer 47. At least a part of the anvil 10 is disposed forward of the hammer 47.

The anvil 10 includes an anvil shaft 10C having a rod-shape and an anvil protrusions 10D. An anvil recess 10B that receives a protrusion of the spindle shaft 8B is provided at a rear end of the anvil 10. A protrusion 8E is provided at a front end of the spindle shaft 8B. The protrusion 8E at the front end of the spindle shaft 8B is inserted into the anvil recess 10B provided at the rear end of the anvil 10. The anvil protrusions 10D are provided at the rear end of the anvil 10. The anvil protrusions 10D protrude to the radial outer side from the rear end of the anvil shaft 10C.

The anvil shaft 10C passes through the front tubular portion 3B from the inside of the hammer case 3 and protrudes forward to the outside of the hammer case 3. A distal end of the anvil shaft 10C is exposed to the outside of the hammer case 3. The anvil 10 is rotatably supported by an anvil bearing 46. The rotation axis of the anvil 10, the rotation axis of the hammer 47, the rotation axis of the spindle 8, and the rotation axis AX of the motor 6 coincide with each other. The anvil 10 rotates about the rotation axis AX. The anvil bearing 46 is disposed on the inner periphery of the front tubular portion 3B of the hammer case 3. The anvil bearing 46 is held by the front tubular portion 3B. The front tubular portion 3B is disposed around the anvil shaft 10C. The anvil bearing 46 supports the anvil shaft 10C in a rotatable manner. A groove 10E facing the front tubular portion 3B is formed on the outer peripheral surface of the anvil shaft 10C. A lubricant is placed in the groove 10E. A gap between a tip opening of the front tubular portion 3B and the anvil shaft 10C is sealed by a seal member 46A.

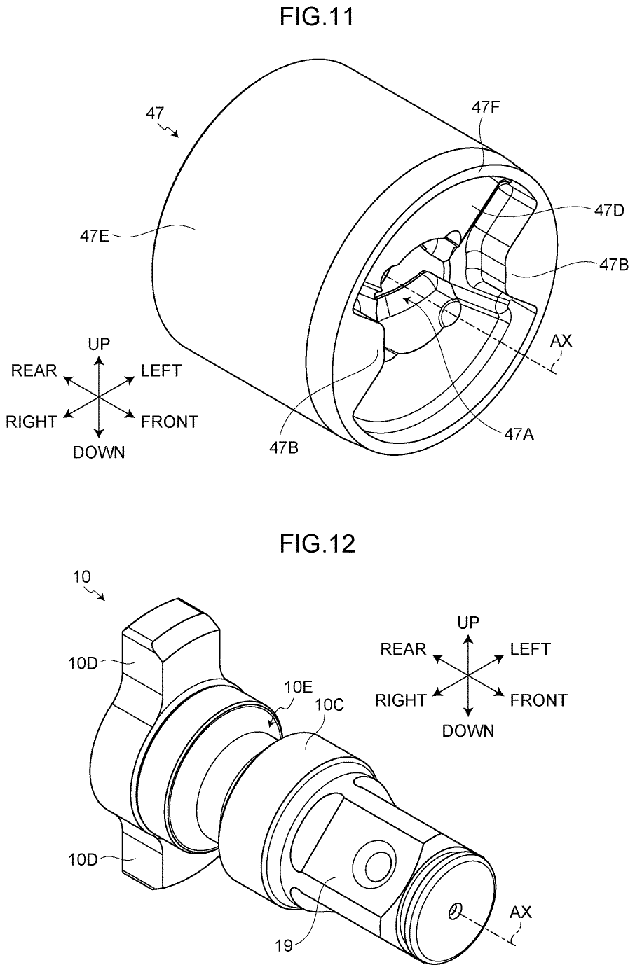

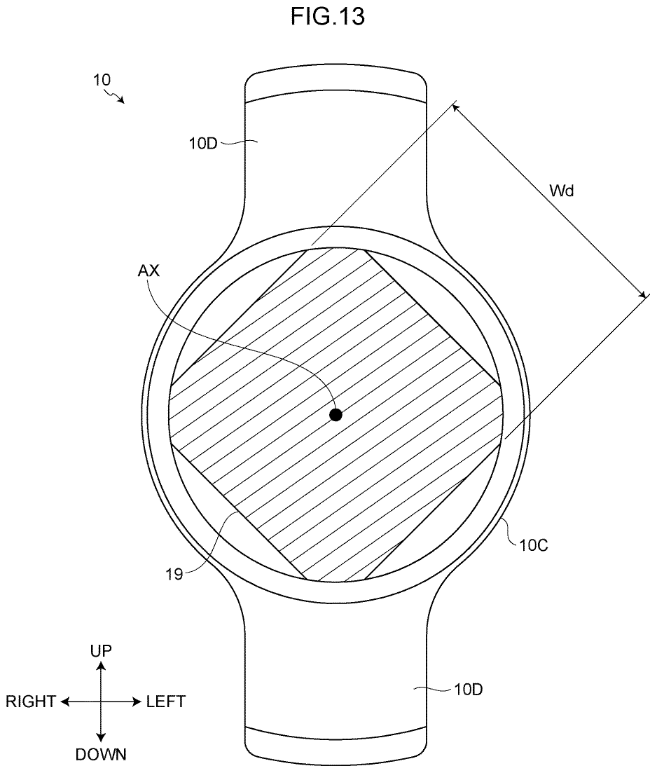

FIG. 12 is a perspective view illustrating the anvil 10 according to the embodiment. FIG. 13 is a cross-sectional view illustrating the tip tool holder 19 according to the embodiment. The anvil 10 includes the tip tool holder 19 at the distal end thereof. The tip tool holder 19 protrudes forward from the front tubular portion 3B of the hammer case 3. The tip tool holder 19 is provided on an exposed portion at the distal end of the anvil shaft 10C. The tip tool holder 19 is rotated by the spindle 8. That is, the tip tool holder 19 is rotated via the hammer 47 and the anvil 10 rotated by the spindle 8. The tip tool holder 19 is integrally formed with the anvil shaft 10C.

In the impact wrench according to the embodiment, the tip tool holder 19 is an engagement portion having square columnar shape, and engages with an engagement recess of a socket that is a tip tool. The socket is held in a state of being fitted to the tip tool holder 19.

FIG. 13 illustrates a cross section orthogonal to the rotation axis AX of the tip tool holder 19. The tip tool holder 19 has a width across flats Wd of 1 inch or more in the cross section orthogonal to the rotation axis AX. The width across flats Wd of the tip tool holder 19 is a distance between two opposite sides of the tip tool holder 19 in the cross section, and represents the size of an engagement portion of an engageable tip tool. The cross-sectional shape of the tip tool holder 19 may be a hexagonal shape other than the square shape. The tip tool holder 19 has the width across flats Wd of, for example, 1 inch or 1 and ½ inches ( 3/2 inches).

The anvil 10 is roughly classified into a short type (short anvil) in which an axial length of the anvil shaft 10C (length from the bearing to the tip tool holder 19) is small and a long type (long anvil) in which the axial length of the anvil shaft 10C is large. The short type has, for example, the axial length of 50 mm or less. The long type has, for example, the axial length of 150 mm or more. The drawings illustrate the anvil 10 of the short anvil type. The anvil 10 may be the long type (long anvil).

In the case of the short type, in the embodiment, the weight of the anvil 10 is 500 g or more. In one example, the weight of the anvil 10 is 510 g or more. In another example, the weight of the anvil 10 is 530 g or more. For example, the weight of the anvil 10 is 2000 g or less. In one example, the weight of the anvil 10 is 1690 g or less. In another example, the weight of the anvil 10 is 1150 g or less. In yet another example, the weight of the anvil 10 is 580 g or less.

In the embodiment, the moment of inertia of the anvil 10 is 85.0 kg·mm² or more. In one example, the anvil 10 has the moment of inertia of 90.0 kg·mm² or more. In another example, the anvil 10 has the moment of inertia of 99.0 kg·mm² or more. For example, the moment of inertia of the anvil 10 is 750 kg·mm² or less. In one example, the anvil 10 has the moment of inertia of 565 kg·mm² or less. In another example, the anvil 10 has the moment of inertia of 124 kg·mm² or less.

In the case of the long type, the weight of the anvil is 1000 g or more. In one example, the weight of the anvil is 1150 g or more. In another example, the weight of the anvil is 1310 g or more. For example, the weight of the anvil is 2800 g or less. In one example, the weight of the anvil is 2620 g or less. In another example, the weight of the anvil is 2160 g or less. In yet another example, the weight of the anvil is 1490 g or less.

The moment of inertia of the long-type anvil is 150 kg·mm² or more. In one example, the anvil has the moment of inertia of 195 kg·mm² or more. In another example, the anvil has the moment of inertia of 250 kg·mm² or more. For example, the moment of inertia of the anvil is 460 kg·mm² or less. In one example, the anvil has the moment of inertia of 410 kg·mm² or less. In another example, the anvil has the moment of inertia of 345 kg·mm² or less.

As illustrated in FIG. 5, in the embodiment, a distance D51 in the up-down direction between the central axis (rotation axis AX) of the anvil 10 and the upper surface of the hammer case 3 is 58 mm or less. In the embodiment, the upper surface of the hammer case 3 is specifically a position at an uppermost point 3E in the outer peripheral surface (upper surface) of the hammer case 3. Preferably, the distance D51 is 56 mm or less. More preferably, the distance D51 is 54 mm or less. In the configuration example illustrated in FIG. 5, the distance D51 in the up-down direction between the central axis of the anvil 10 and the upper surface of the hammer case 3 is 53 mm.

As illustrated in FIGS. 9, 11, and 12, the hammer protrusions 47B can come in contact with the anvil protrusions 10D. When the motor 6 is driven in a state that the hammer protrusions 47B and the anvil protrusions 10D are in contact with each other, the anvil 10 rotates together with the hammer 47 and the spindle 8.

The anvil 10 is impacted in the rotation direction by the hammer 47. For example, when a load acting on the anvil 10 becomes high during the screw-tightening work, the anvil 10 can no longer be caused to rotate only by the power generated by the motor 6. When the anvil 10 can no longer be cause to rotate only by the power generated by the motor 6, the rotation of the anvil 10 and the hammer 47 temporarily stops. The spindle 8 and the hammer 47 are movable relative to each other in both the axial direction and the circumferential direction via the balls 48. Even when the rotation of the hammer 47 temporarily stops, the rotation of the spindle 8 is continues owing to the power generated by the motor 6. Thus, when the rotation of the hammer 47 has temporarily stopped and the spindle 8 continues to rotate, the balls 48 moves rearward while being guided by the spindle grooves 8F and the hammer grooves 47A. The hammer 47 receives a force from the balls 48 and moves rearward with the balls 48. That is, while the rotation of the anvil 10 is temporarily stopped, the hammer 47 moves rearward owing to the rotation of the spindle 8. When the hammer 47 moves rearward, the contact between the hammer protrusions 47B and the anvil protrusions 10D is released.

The hammer 47 that has moved rearward is then moved forward by the elastic force of the spring 49. When moving forward, the hammer 47 receives a force in the rotation direction from the balls 48. That is, the hammer 47 moves forward while rotating. When the hammer 47 moves forward while rotating, the hammer protrusions 47B come into contact with the anvil protrusions 10D while rotating. This allows the anvil protrusions 10D to be impacted in the rotation direction by the hammer protrusions 47B. The power of the motor 6 and the inertial force of the hammer 47 both act on the anvil 10 at this time. Therefore, the anvil 10 can rotate about the rotation axis AX with higher torque.

While the spindle 8 is rotating by the motor 6 after the hammer 47 starts to impact the anvil 10, the hammer 47 repeats, a series of movements including: retracting (rearward movement) from the anvil 10; release of contact with the anvil 10; advancing (forward movement) to the anvil 10; and impact on the anvil 10 (re-contact with the anvil 10). In the present teachings, a forward/rearward moving distance Ls along the rotation axis AX of the hammer 47 is referred to as a stroke of the hammer 47.

In the embodiment, the forward/rearward moving distance Ls (stroke) of the hammer 47 along the spindle 8 is 12 mm or more and 25 mm or less. In one example, the forward/rearward moving distance Ls of the hammer 47 is 14.0 mm or more. In another example, the forward/rearward moving distance Ls of the hammer 47 is 13.5 mm or more. In one example, the forward/rearward moving distance Ls of the hammer 47 is 20.0 mm or less. In another example, the forward/rearward moving distance Ls of the hammer 47 is 15.0 mm or less.

In the embodiment, the number of impacts per rotation of the hammer 47 is larger than 1. In one example, the number of impacts per rotation of the hammer 47 is 1 or more. In another example, the number of impacts per rotation of the hammer 47 is 2 or more. In still another example, the number of impacts per rotation of the hammer 47 is 3 or more.

Each time the hammer 47 impacts the anvil 10, an impulsive torque acts on the fastening member engaged with the anvil 10 via the tip tool. In the screw tightening work, the fastening member is further tightened every time the impact torque acts thereon, so that the tightening torque applied to the fastening member increases with the number of impacts.

With the above configuration, the impact mechanism 9 converts continuous torque input from the motor 6 into an consecutive rotational impacts capable of generating a predetermined tightening torque or more to the fastening member by the anvil 10. In the embodiment, the maximum tightening torque of the anvil 10 is 2500 Nm or more. Preferably, the maximum tightening torque of the anvil 10 is 2700 Nm or more. More preferably, the maximum tightening torque of the anvil 10 is 3000 Nm or more. More preferably, the maximum tightening torque of the anvil 10 is 5000 Nm or more.

Although it is considered that the tightening torque caused by the impact converges to a certain value when the tightening work is performed for a long time, measurement is difficult. Therefore, the tightening torque is defined as the maximum value (maximum tightening torque) of the tightening torque achieved in a certain measurement time. Note that the maximum tightening torque is the torque of when tightening the fastening member, and generally refers to the torque measured for a further tightening torque wrench or the like with respect to the member to be tightened after it has been tightened. Note that this is not a method in which the measurement is performed by loosening a nut or a bolt. Typically, maximum tightening torque is listed in catalogs of respective manufacturers.

In one example, the maximum tightening torque of the anvil 10 is 2700 Nm or more in six-second tightening (i.e., measurement time is six seconds.). In another example, the maximum tightening torque of the anvil 10 is 3150 Nm or more at six-second tightening. In yet another example, the maximum tightening torque of the anvil 10 is 5000 Nm or more in six-second tightening.

In one example, the maximum tightening torque of the anvil 10 is 2500 Nm or more in three-second tightening (i.e., measurement time is three seconds.). In another example, the maximum tightening torque of the anvil 10 is 2850 Nm or more in three-second tightening. In yet another example, the maximum tightening torque of the anvil 10 is 4100 Nm or more in three-second tightening.

In the case of the screw loosening work such as a case of removing the fixed fastening member, the torque acting on the fastening member peaks at the beginning of the rotation of the fastening member. The torque applied to the fastening member in the screw loosening work is referred to as nut-busting torque. The nut-busting torque is an upper limit value of the torque at which the loosening work of the fastening member is possible.

In the embodiment, the nut-busting torque of the anvil 10 is 2800 Nm or more. In one example, the nut-busting torque of the anvil 10 is 3150 Nm or more. In another example, the nut-busting torque of the anvil 10 is 4000 Nm or more. In yet another example, the nut-busting torque of the anvil 10 is 6500 Nm or more.

Table 1 shows one configuration example of the impact tool 1 according to the embodiment. Table 1 shows Configuration Examples 1 to 3 of the embodiment, and Comparative Examples 1 and 2 of a conventional pistol-shaped battery-powered impact tool. The maximum tightening torque in Table 1 is the maximum value of the tightening torque in “six-second tightening”.

TABLE 1

| | | Configuration | Configuration | Configuration | Comparative | Comparative |
|---|---|---|---|---|---|---|
| | | Example 1 | Example 2 | Example 3 | Example 1 | Example 2 |
| Maximum tightening torque (N · m) | | 2,580 | 3,150 | 5,000 | 1,050 | 1,800 |
| Nut-busting torque (N · m) | | 3,000 | 4,000 | 7,500 | 1,700 | 2,050 |
| Width across flats of tip tool holder (in) | | 1 | 1 | 1.5 | 3/4 | 3/4 |
| Hammer blows per revolution (times) | | 2 | 2 | 2 | 2 | 2 |
| Impacts per minute (min-1) | | 1,910 | 1,750 | 1,500 | 2,200 | 2,500 |
| Energy per impact (J) | | 5.52 | 6.75 | 14.36 | 3.03 | 3.33 |
| Current (A) | | 44-48 | 42-43 | 84-88 | 50-53 | 32-35 |
| Voltage (V) | | 36 | 36 | 36 | 18 | 36 |
| Spring | Wire diameter (mm) | 7.5 | 10.0 | 11.0 | 6.5 | 6.5 |
| | Coil inner diameter (mm) | 46.0 | 58.0 | 68.0 | 38.0 | 41.0 |
| | Free length (mm) | 48.0 | 60.5 | 73.0 | 52.5 | 45.0 |
| | Preload length (mm) | 41.0 | 56.0 | 63.0 | 46.0 | 39.0 |
| | Preload (N) | 705.1 | 698.0 | 1,447.7 | 428.0 | 487.0 |
| | Spring constant (N/mm) | 100.7 | 155.1 | 144.7 | 65.8 | 81.2 |
| Spindle | Diameter (mm) | 26.0 | 33.0 | 49.5 | 22.0 | 22.0 |
| | Lead angle (deg) | 31.7 | 27.4 | 27.4 | 31.1 | 31.0 |
| | Weight (g) | 331.9 | 892 | 966 | 241.9 | 256.2 |
| | Moment of inertia | 79.70 | 419.00 | 469.20 | 38.96 | 60.18 |
| | (kg*mm²) | | | | | |
| Ball | Ball diameter (mm) | 7.9 | 10.3 | 10.3 | 7.1 | 7.1 |
| | Weight (g) | 2.02 | 4.5 | 4.5 | 1.47 | 1.47 |
| | Moment of inertia | 0.0126 | 0.0475 | 0.0475 | 0.0074 | 0.0074 |
| | (kg*mm²) | | | | | |
| Hammer | Weight (g) | 1,045 | 1,215 | 2,096 | 570 | 529 |
| | Moment of inertia | 1,103 | 1,609 | 4,657 | 456 | 389 |
| | (kg*mm²) | | | | | |
| | Size (diameter × height) | 82.9 × 44.5 | 100 × 56.6 | 121 × 62.7 | 65.8 × 51.0 | 68.0 × 48.0 |
| | Stroke (mm) | 14.0 | 22.5 | 25.0 | 14.0 | 14.0 |
| Anvil | Weight (g) | 533 | 580 | 1690 | 223 | 214 |
| | Moment of inertia | 99.0 | 123.5 | 562.0 | 27.0 | 27.0 |
| | (kg*mm²) | | | | | |
| Speed | Gear ratio | 15.67 | 15.16 | 15.26 | 10.00 | 15.67 |
| reduction | | | | | | |
| mechanism | | | | | | |

### Configuration Example 1

In Configuration Example 1, the maximum tightening torque of the anvil 10 is 2580 Nm in six-second tightening. In Configuration Example 1, the nut-busting torque of the anvil 10 is 3000 Nm. The anvil 10 of Configuration Example 1 has the tip tool holder 19 whose width across flats Wd is 1 inch. In Configuration Example 1, the number of impacts per rotation of the hammer 47 is 2. In Configuration Example 1, the number of impacts per minute is 1910. In Configuration Example 1, the motor current value is 44 A or more and 48 A or less. In Configuration Example 1, the voltage of the battery pack 80 is 36 V.

The spring 49 of Configuration Example 1 has the wire diameter D41 of 7.5 mm. The spring 49 of Configuration Example 1 has the coil inner diameter D42 of 46.0 mm. The spring 49 of Configuration Example 1 has the free length of 48.0 mm. The spring 49 of Configuration Example 1 has the preload length L41 of 41.0 mm. The spring 49 of Configuration Example 1 applies the preload of 705.1 N to the hammer 47. The spring 49 of Configuration Example 1 has the spring constant of 100.7 N/mm.

The spindle shaft 8B of the spindle 8 in Configuration Example 1 has the diameter D21 of 26.0 mm. The spindle groove 8F of the spindle 8 in Configuration Example 1 has the lead angle of 31.7 degrees. The spindle 8 in Configuration Example 1 has the weight of 331.9 g. The spindle 8 in Configuration Example 1 has the moment of inertia of 79.70 kg·mm².

The ball 48 in Configuration Example 1 has the diameter of 7.9 mm. The ball 48 in Configuration Example 1 has the weight of 2.02 g. The ball 48 in Configuration Example 1 has the moment of inertia of 0.0126 kg·mm².

The hammer 47 in Configuration Example 1 has the weight of 1045 g. The hammer 47 in Configuration Example 1 has the moment of inertia of 1103 kg·mm². The hammer 47 in Configuration Example 1 has the diameter D31 of 82.9 mm and the total length L31 of 44.5 mm. The front-rear moving distance Ls along the spindle 8 of the hammer 47 in Configuration Example 1 is 14.0 mm.

The anvil 10 in Configuration Example 1 has the weight of 533 g. The anvil 10 in Configuration Example 1 has the moment of inertia of 99.0 kg·mm².

In the speed reduction mechanism 7 of Configuration Example 1, a speed reduction ratio between the pinion gear 41 and the spindle 8 is 15.67.

### Configuration Example 2

In Configuration Example 2, the maximum tightening torque of the anvil 10 is 3150 Nm in six-second tightening. In Configuration Example 2, the nut-busting torque of the anvil 10 is 4000 Nm. The anvil 10 in Configuration Example 2 has the tip tool holder 19 whose width across flats Wd is 1 inch. In Configuration Example 2, the number of impacts per rotation of the hammer 47 is 2. In Configuration Example 2, the number of impacts per minute is 1750. In Configuration Example 2, the motor current value is 42 A or more and 43 A or less. In Configuration Example 2, the voltage of the battery pack 80 is 36 V.

The spring 49 in Configuration Example 2 has the wire diameter D41 of 10.0 mm. The spring 49 in Configuration Example 2 has the coil inner diameter D42 of 58.0 mm. The spring 49 in Configuration Example 2 has the free length of 60.5 mm. The spring 49 in Configuration Example 2 has the preload length L41 of 56.0 mm. The spring 49 in Configuration Example 2 applies the preload of 698.0 N to the hammer 47. The spring 49 in Configuration Example 2 has the spring constant of 155.1 N/mm.

The spindle shaft 8B of the spindle 8 in Configuration Example 2 has the diameter D21 of 33.0 mm. The spindle groove 8F of the spindle 8 in Configuration Example 2 has the lead angle of 27.4 degrees. The spindle 8 in Configuration Example 2 has the weight of 892 g. The spindle 8 in Configuration Example 2 has the moment of inertia of 419.00 kg·mm².

The ball 48 in Configuration Example 2 has the diameter of 10.3 mm. The ball 48 in Configuration Example 2 has the weight of 4.5 g. The ball 48 in Configuration Example 2 has the moment of inertia of 0.0475 kg·mm².

The hammer 47 in Configuration Example 2 has a weight of 1215 g. The hammer 47 in Configuration Example 2 has the moment of inertia of 1609 kg·m². The hammer 47 in Configuration Example 2 has the diameter D31 of 100 mm and the total length L31 of 56.6 mm. The front-rear moving distance Ls along the spindle 8 of the hammer 47 in Configuration Example 2 is 22.5 mm.

The anvil 10 in Configuration Example 2 has the weight of 580 g. The anvil 10 in Configuration Example 2 has the moment of inertia of 123.5 kg·mm².

In the speed reduction mechanism 7 of Configuration Example 2, the speed reduction ratio between the pinion gear 41 and the spindle 8 is 15.16.

### Configuration Example 3

In Configuration Example 3, the maximum tightening torque of the anvil 10 is 5000 Nm in six-second tightening. In Configuration Example 3, the nut-busting torque of the anvil 10 is 7500 Nm. The anvil 10 of Configuration Example 3 has the tip tool holder 19 whose width across flats Wd is 1.5 inches. In Configuration Example 3, the number of impacts per rotation of the hammer 47 is 2. In Configuration Example 3, the number of impacts per minute is 1500. In Configuration Example 3, the motor current value is 84 A or more and 88 A or less. In Configuration Example 3, the voltage of the battery pack 80 is 36 V.

The spring 49 in Configuration Example 3 has the wire diameter D41 of 11.0 mm. The spring 49 in Configuration Example 3 has the coil inner diameter D42 of 68.0 mm. The spring 49 in Configuration Example 3 has the free length of 73.0 mm. The spring 49 in Configuration Example 3 has the preload length L41 of 63.0 mm. The spring 49 in Configuration Example 3 applies the preload of 1447.7 N to the hammer 47. The spring 49 of Configuration Example 3 has the spring constant of 144.7 N/mm.

The spindle shaft 8B of the spindle 8 in Configuration Example 3 has the diameter D21 of 49.5 mm. The spindle groove 8F of the spindle 8 in Configuration Example 3 has a lead angle of 27.4 degrees. The spindle 8 in Configuration Example 3 has the weight of 966 g. The spindle 8 in Configuration Example 3 has the moment of inertia of 469.20 kg·mm².

The ball 48 in Configuration Example 3 has the diameter of 10.3 mm. The ball 48 in Configuration Example 3 has the weight of 4.5 g. The ball 48 in Configuration Example 3 has the moment of inertia of 0.0475 kg·mm².

The hammer 47 in Configuration Example 3 has the weight of 2096 g. The hammer 47 in Configuration Example 3 has the moment of inertia of 4657 kg mm². The hammer 47 in Configuration Example 3 has the diameter D31 of 121 mm and the total length L31 of 62.7 mm. The front-rear moving distance Ls along the spindle 8 of the hammer 47 in Configuration Example 3 is 25.0 mm.

The anvil 10 in Configuration Example 3 has the weight of 1690 g. The anvil 10 in Configuration Example 3 has the moment of inertia of 562.0 kg·mm².

In the speed reduction mechanism 7 of Configuration Example 3, the speed reduction ratio between the pinion gear 41 and the spindle 8 is 15.26.

### Comparative Example 1

In Comparative Example 1, the maximum tightening torque of the anvil is 1050 Nm in three-second tightening. In Comparative Example 1, the nut-busting torque of the anvil is 1700 Nm, and the width across flats of the tip tool holder in Comparative Example 1 is ¾ inch. In Comparative Example 1, the number of impacts per rotation of the hammer 47 is 2. In Comparative Example 1, the number of impacts per minute is 2200. In Comparative Example 1, the motor current value is 50 A or more and 53 A or less. In Comparative Example 1, the voltage of the battery pack 80 is 18 V.

Specification values of the spring, the spindle, the ball, the hammer, the anvil, and the speed reduction mechanism in Comparative Example 1 are as indicated in Table 1.

### Comparative Example 2

In Comparative Example 2, the maximum tightening torque of the anvil is 1800 Nm in three-second tightening. In Comparative Example 2, the nut-busting torque of the anvil is 2050 Nm. The width across flats of the tip tool holder in Comparative Example 2 is ¾ inch. In Comparative Example 2, the number of impacts per rotation of the hammer 47 is 2. In Comparative Example 2, the number of impacts per minute is 2500. In Comparative Example 2, the motor current value is 32 A or more and 35 A or less. In Comparative Example 2, the voltage of the battery pack 80 is 36 V.

Specification values of the spring, the spindle, the ball, the hammer, the anvil, and the speed reduction mechanism in Comparative Example 2 are as indicated in Table 1.

As shown in Table 1, in Configuration Examples 1 to 3 according to the embodiment, the pistol-shaped battery-powered impact tool can generate the maximum tightening torque of 2500 Nm or more. In Comparative Examples 1 and 2 exemplified as conventional pistol-shaped battery-powered impact tools, the maximum tightening torques are 1050 Nm and 1800 Nm, respectively. As described above, in Configuration Examples 1 to 3 according to the embodiment, the tightening torque is improved as compared with the related art in the pistol-shaped battery-powered impact tool.

### Effects

As described above, in the embodiment, the impact tool 1 includes: the motor 6 having the rotor 27 that is rotatable about the rotation axis AX extending in the front-rear direction and the stator 26 to rotate the rotor 27; the motor housing portion 21 that houses the motor 6; the grip portion 22 that extends downward from the motor housing portion 21; the battery holding portion 23 that is disposed below the grip portion 22 and detachably holds the battery pack 80 for supplying electric power to the motor 6; the spindle 8 that is rotated by the rotor 27 and extends along the rotation axis AX; the hammer 47 that is rotated by the spindle 8, the anvil 10 that is disposed forward of the hammer 47 and includes, at the distal end thereof, the tip tool holder 19 having the width across flats Wd of 1 inch or more in the cross section orthogonal to the rotation axis AX; and the spring 49 that biases the hammer 47 toward the anvil 10. The maximum tightening torque of the anvil 10 is 2500 Nm or more.

In the above configuration, the pistol-shaped battery-powered impact tool, which includes: the motor 6; the motor housing portion 21 that houses the motor 6; the grip portion 22 that extends downward from the motor housing portion 21; and the battery holding portion 23 that is disposed below the grip portion 22, can be mounted with a large tip tool of 1 inch or more, and can provide the tightening torque of 2500 Nm or more to the fastening member. Accordingly, the tightening torque can be improved in the pistol-shaped battery-powered impact tool.

In the embodiment, the weight of the hammer 47 is 800 g or more.

In the above configuration, the impact force of the hammer 47 is improved, so that a higher tightening torque can be achieved in the pistol-shaped battery-powered impact tool.

In the embodiment, the number of impacts per rotation of the hammer 47 is larger than 1.

In the above configuration, the number of impacts of the hammer 47 is increased, so that a higher tightening torque can be achieved in a short time in the pistol-shaped battery-powered impact tool.

In the embodiment, the moment of inertia of the hammer 47 is 900 kg·mm² or more.

In the above configuration, the impact force of the hammer 47 is improved, so that a higher tightening torque can be achieved in the pistol-shaped battery-powered impact tool.

In the embodiment, the diameter D31 of the hammer 47 is 70 mm or more. The total length L31 of the hammer 47 may be 35 mm or more.

In the above configuration, the diameter of the hammer 47 is increased, so that the impact force of the hammer 47 can be effectively improved.

In the embodiment, the total length L31 of the hammer 47 is 60% or less of the diameter D31 of the hammer 47.

In the above configuration, it is possible to suppress the dimension in the front-rear direction while improving the impact force of the hammer 47. Since an increase in the front-rear dimension of the pistol-shaped impact tool is suppressed, it is possible to retain easy handling that is a strong feature of the pistol-shaped impact tool even when the tightening torque is improved.

In the embodiment, the hammer 47 rotates about the rotation axis AX while moving in the front-rear direction along the spindle 8 so as to impact the anvil 10 in the rotation direction. The moving distance Ls of the hammer 47 in the front-rear direction along the spindle 8 is 12 mm or more and 25 mm or less.

In the above configuration, even when a higher tightening torque is achieved, it is possible to suppress an increase in the moving distance Ls of the hammer 47 in the front-rear direction. As a result, easy handling that is a strong feature of the pistol-shaped impact tool can be retained.

In the embodiment, the nut-busting torque of the anvil 10 is 2800 Nm or more.

In the above configuration, it is possible to achieve a higher nut-busting torque required when loosening the fastening member firmly stuck due to rust or the like.

In the embodiment, the weight of the anvil 10 is 500 g or more.

The above configuration contributes to achieving a higher tightening torque.

In the embodiment, the moment of inertia of the anvil 10 is 85.0 kg·mm² or more.

The above configuration contributes to achieving a higher tightening torque.

In the embodiment, the spring constant of the spring 49 is 80 N/mm or more.

In the above configuration, the elastic force required when the hammer 47 is increased in size can be generated even with a short stroke. Since the moving distance Ls of the hammer 47 in the front-rear direction can be suppressed, it is possible to suppress an increase in the dimension of the impact tool in the front-rear direction.

In the embodiment, the impact tool 1 includes the hammer case 3 that is disposed forward of the motor housing portion 21 and houses a part of the hammer 47 and the anvil 10 while causing the tip tool holder 19 to protrude forward. The distance D51 in the up-down direction between the central axis of the anvil 10 and the upper surface of the hammer case 3 is 58 mm or less.

In the above configuration, the distance D51 in the up-down direction from the upper surface of the impact tool 1 to the central axis of the anvil 10 is shortened. This improves convenience when working in confined spaces, such as when tightening the fastening member at a corner of a structure.

In the embodiment, the nominal diameter D11 of the motor 6 is 50 mm or more. The stacking thickness L11 of the stator 26 is 20 mm or more.

In the above configuration, the motor output (rotation speed and rotation torque of the hammer 47) required for improving the tightening torque can be achieved.

In the embodiment, the impact tool 1 further includes the trigger lever 14 that is operated to start the motor 6. The trigger lever 14 is disposed downward of the motor housing portion 21 on the grip portion 22.

In the above configuration, the tightening work can be performed by operating the trigger lever 14 of the grip portion 22 in the pistol-shaped battery-powered impact tool.

### OTHER EMBODIMENTS

In the above-described embodiment, numerical values given in configuration examples are examples, and are not limited thereto.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An impact tool comprising:
a motor including a rotor that is rotatable about a rotation axis extending in a front-rear direction and a stator to rotate the rotor;
a motor housing portion that houses the motor;
a grip portion that extends downward from the motor housing portion;
a battery holding portion that is disposed below the grip portion and detachably holds a battery pack for supplying electric power to the motor;
a spindle that is rotated by the rotor and extends along the rotation axis;
a hammer that is rotated by the spindle;
an anvil that is disposed forward of the hammer and includes, at a distal end thereof, a tip tool holder having a width across flats of 1 inch or more in a cross section orthogonal to the rotation axis; and
a spring that biases the hammer toward the anvil, wherein
a maximum tightening torque of the anvil is 2500 Nm or more.

2. The impact tool according to claim 1, wherein
a weight of the hammer is 800 g or more.

3. The impact tool according to claim 1, wherein
the number of impacts per rotation of the hammer is larger than 1.

4. The impact tool according to claim 1, wherein
the hammer has a moment of inertia of 900 kg·mm² or more.

5. The impact tool according to claim 1, wherein
the hammer has a diameter of 70 mm or more, and
the hammer has a total length of 35 mm or more.

6. The impact tool according to claim 5, wherein
the total length of the hammer is 60% or less of the diameter of the hammer.

7. The impact tool according to claim 1, wherein
the hammer rotates about the rotation axis while moving in the front-rear direction along the spindle so as to impact the anvil in a rotation direction, and
a moving distance of the hammer in the front-rear direction along the spindle is 12 mm or more and 25 mm or less.

8. The impact tool according to claim 1, wherein
the anvil has nut-busting torque of 2800 Nm or more.

9. The impact tool according to claim 1, wherein
a weight of the anvil is 500 g or more.

10. The impact tool according to claim 1, wherein
the anvil has a moment of inertia of 85.0 kg·mm² or more.

11. The impact tool according to claim 1, wherein
the spring has a spring constant of 80 N/mm or more.

12. The impact tool according to claim 1, further comprising
a hammer case that is disposed forward of the motor housing portion and houses a part of the hammer and the anvil while causing the tip tool holder to protrude forward, wherein
a distance in an up-down direction between a central axis of the anvil and an upper surface of the hammer case is 58 mm or less.

13. The impact tool according to claim 1, wherein
the motor has a nominal diameter of 50 mm or more, and
the stator has a stacking thickness of 20 mm or more.

14. The impact tool according to claim 1, further comprising
a trigger lever that is operated to start the motor, wherein
the trigger lever is disposed downward of the motor housing portion on the grip portion.
